(19) United States
(12) Patent Application Publication
(10) Pub. No.: US 2015/0299040 A1
(43) Pub. Date: Oct. 22, 2015

(54) MOLTEN SALT SYNTHESIS FOR MANUFACTURE OF CEMENT PRECURSORS

(71) Applicant: VERDANT CEMENT LLC, Wilmette, IL (US)

(72) Inventor: Jonathan Blake NELSON, Wilmette, IL (US)

(21) Appl. No.: 14/441,708

(22) PCT Filed: Nov. 8, 2013
(86) PCT No.: PCT/US2013/069247

§ 371 Date: May 8, 2015

Related U.S. Application Data
(60) Provisional application No. 61/724,552, filed on Nov. 9, 2012.
(60) Provisional application No. 61/734,092, filed on Dec. 6, 2012.
(60) Provisional application No. 61/782,557, filed on Mar. 14, 2013.

(51) Int. Cl. C04B 7/38; C04B 7/02

(52) U.S. Cl. CPC C04B 7/38; C04B 7/02

(57) ABSTRACT

A method of manufacturing calcium silicates, calcium aluminates, calcium aluminosilicates and calcium ferrites and the products thereby derived utilizing molten-salt synthesis and/or molten-salt sintering. Molten-salt synthesis enables efficiently manufacture calcium silicate (Ca—SiO₃), dicalcium silicate (Ca₂SiO₄), tricalcium disilicate (Ca₃Si₂O₇) and related compounds such as calcium aluminate (CaAl₂O₄), Gehlenite (Ca₂Al₂—SiO₇) and tetracalcium aluminoferrite (Ca₄Al₂Fe₂O_{O}₁₀) at temperatures in the range of about 400-750° C. The composition of the synthesized product(s) can be varied by altering the ratio of the precursor compounds and by changing the molten-salt composition, whether used as a sintering flux or molten bath, resulting in the ability to manufacture calcium silicates and related compounds for a wide variety of uses, but most specifically as precursors to the manufacture of hydraulic cements or for use in hydraulic cements such as Portland cements and calcium aluminate and other cements.

### CROSS REFERENCE TO RELATED APPLICATIONS

This is a utility application incorporating by reference and claiming priority to provisional application Ser. Nos. 61/782,557 filed Mar. 14, 2013 entitled “Process and Compounds for Manufacture of Cement”, 61/734,092 filed Dec. 6, 2012 entitled “Process and Compounds for Manufacture of Cement” and 61/724,552 filed Nov. 9, 2012 entitled “Process and Compounds for Manufacture of Cement”.

### BACKGROUND OF THE INVENTION

A. Field of the Invention

The present invention relates to the manufacture of calcium silicates, calcium aluminates, calcium aluminosilicates and calcium ferrites from calcium carbonate (CaCO₃), silica (SiO₂) and related compounds (primarily Al₂O₃ containing clays and Fe₂O₃). The resulting calcium silicates and related compounds have a wide variety of uses, but most specifically as precursors to or as the actual components of hydraulic cements such as Portland cements and calcium aluminate cements.

B. Description of the Prior Art

Cement is the “glue” that holds a concrete mixture together. In 2010, worldwide cement production was 3.3 billion metric tons (Mt) worth an estimated $264 billion. This quantity of cement is sufficient for about 21 billion metric tons per year of concrete, and makes cement the most abundant of all manufactured solid materials.

Cement is manufactured in a high temperature furnace known as a kiln. There are several types of kilns in use around the world, each with different advantages and disadvantages. Regardless of the type of kiln, the raw materials used to produce cement are heated to approximately 1450° C., where, in a partially melted state, they react to form the minerals crucial to cement's utility.

A variety of fossil fuels and waste fuels are used to heat the cement precursor raw materials in kilns to reach the reaction temperature to produce cement. The most commonly used fuel is coal—although use of natural gas is rapidly expanding in some markets due to comparatively lower cost. The process of producing cement is extremely energy and greenhouse gas intensive; energy accounts for 20%-40% of cement plant operating cost. In addition, the cement industry accounts for approximately 7% of global anthropogenic CO₂ emissions.

LaFarge, the largest cement manufacturer in the world, reports that energy accounted for 33% of its production costs in 2011, while US Census Bureau data indicates that energy accounted for $20 per metric ton (equal to 23%) of US cement production expenses in 2010. More energy is consumed manufacturing cement than virtually any other material because the amount of cement manufactured is much higher. Thus, the cement industry is by far the largest energy consumer and CO₂ emitter in the non-metallic minerals industry, accounting for 85% of all energy use and 2.4 billion metric tons of CO₂ generation in 2010 (7.2% of all man-made CO₂ emissions).

China is the largest cement manufacturer and consumer in the world, representing approximately 50% of production capacity and consumption. Cement manufacturing in China is a fragmented industry dominated by highly inefficient Vertical Shaft kilns. Outside China, cement manufacturing is a diverse but somewhat consolidated industry, where the seven largest manufacturers control over 50% of production capacity. LaFarge controls approximately 16.3% of non-Chinese manufacturing capacity but only 7.4% of worldwide capacity.

The Cement Manufacturing Process

Two major types of raw materials are combined to make cement:

1. Lime-containing materials (i.e. calcium oxide), such as limestone, marble, oyster shells, marl, chalk, etc.

2. Clay and clay-like materials, such as shale, slag from blast furnaces, bauxite, iron ore, silica, sand, etc.

The main oxide in cement is CaO (calcium oxide or lime), and a source of CaO is sought that is abundant, inexpensive, and easily processed to make this oxide available for mineral formation. Calcium carbonate (CaCO₃), commonly referred to as limestone, and similar rocks are the main raw material sources of CaO; cement plants are almost invariably located within a few miles of a limestone quarry. The main CaO-bearing mineral in limestone and related rocks is the calcite form of calcium carbonate.

Three other oxides are also important to the production of cement. These three oxides are SiO₂ (silicon dioxide), Al₂O₃ (aluminum oxide) and Fe₂O₃ (iron oxide), all three being provided primarily by clay and clay-like materials. These four oxides (CaO, SiO₂, Al₂O₃, Fe₂O₃) in various combinations form the major minerals found in cement.

The production of cement takes place in several steps (FIG. 1):

1. Quarrying of limestone and clay—Quarrying of limestone and clay is accomplished by using explosives to blast the rocks from the ground or huge power shovels to dig up clay. After blasting, the raw materials are loaded onto dump trucks or small railroad cars for transportation to the cement plant, which is usually nearby.

2. Grinding—After the raw materials have been transported to the plant, the limestone and clay must be crushed into smaller pieces. Some of the pieces, when blasted out, are quite large. The pieces are dumped into primary crushers that reduce them to the size of softballs. The pieces are carried by conveyors to secondary crushers which crush the rocks into fragments usually no larger than about 2 cm across.

3. Blending—After the rock is crushed, plant chemists analyze the rock and raw materials to determine their mineral content. The chemists also determine the proportions of each raw material to utilize in order to obtain a uniform cement product. The various raw materials are then mixed in proper proportions and prepared for fine grinding.

4. Fine grinding—When the raw materials have been blended, they must be ground into a fine powder. This may be done by one of two methods: the Wet Process, or the Dry Process. The Wet Process of fine grinding is the older process, having been used in Europe prior to the widespread manufacture of cement in the United States. This process is used more often when clay and marl, which are very moist, are included in the composition of the cement. In the Wet Process, the blended raw materials are moved into ball or tube mills which are cylindrical rotating drums containing steel balls. These steel balls grind the raw materials into smaller fragments of up to 100 microns in size. As the grinding is done, water is added until a slurry (thin mud) forms, and the slurry is stored in open tanks where additional mixing is done. Some of the water may be removed from the slurry before it is burned, or the slurry may be sent to a kiln as is and the water evaporated during the burning. The Dry Process of fine grinding is accomplished with a similar set of ball or tube mills; however, water is not added during the grinding. The dry materials are stored in silos where additional mixing and blending may be done. In most of the world, new cement plants are based on the Dry Process as the Wet Process requires approximately 60% more energy.

5. Pyroprocessing—Pyroprocessing is a key step in the cement making process. The wet or dry mix is fed into a kiln, which is one of the largest pieces of moving machinery in industry. A kiln is generally 3 meters or more in diameter and can be 50 to 200 meters or more in length, depending on the type of kiln. The kiln is typically made of steel and lined with firebrick. The kiln rotates on large roller bearings at a rate of 1 to 3 revolutions per minute and is slightly inclined with the intake end higher than the output end. As the kiln rotates, the materials roll and slide downward for 30 minutes to as long as 4 hours, again, depending on the kiln type. In the “burning zone,” where the temperature can reach 1500° C., the materials become incandescent and change in color from purple to violet to orange. Here, gases are driven from the raw materials and the remaining oxides interact to form new minerals. What emerges are mineral globules of “clinker”—round, golf ball-sized spheres that are harder than the quarried rock. The clinker is then fed into a cooler where it is cooled for storage.

As noted in Table 1, the minerals in cement clinker have different functions related either to the manufacturing process or the final properties of cement. Thus, for example, the primary function of the “ferrite” mineral (C4AF) is to lower the temperature required in the kiln to form the C3S mineral, rather than impart some desired property to the cement. In contrast, the proportion of C3S determines the degree of early strength development of the cement and the proportion of C2S determines the degree of late strength development of the cement.

TABLE 1
Typical mineralogical composition of modern Portland cement clinker

| Chemicaₗ | | Shorthand | | Typical | |
|---|---|---|---|---|---|
| _{f}ormula | Oxide formula | notation | Description | percentage | Mineral function |
| Ca₃SiO₅ | (CaO)₃(SiO₂) | C3S | Tricalcium silicate | 50-70 | Imparts early |
| | | | (“alite”) | | strength and set. |
| Ca₂SiO₄ | (CaO)₂(SiO₂) | C2S | Di_{c}al_{c}iᵤm silicate | 10-30 | Imparts additional |
| | | | (“belite”) | | long-term strength. |
| Ca₃Al₂O₆ | (CaO)₃(Al₂O₃) | C3A | Tricalcium | 3-13 | Acts as a flux in |
| | | | aluminate | | clinker |
| | | | | | manufacture. |
| Ca₄Al₂Fe₂O₁₀ | (CₐO)₄(Al₂O₃)(Fe₂O₃) | C₄AF | _{T}etᵣacₐl_{ci}um | 5-15 | Contributes to |
| | | | aluminoferrite | | early strength and |
| | | | | | set. |
| | | | | | Acts as a flux in |
| | | | | | clinker |
| | | | | | manufacture. |
| | | | | | Imparts gray color. |

6. Finish grinding—The cooled clinker is mixed with a small amount of gypsum (CaSO₄), which will help regulate the setting time when the cement is mixed with other materials (e.g. gravel, sand, etc.) and becomes concrete. Here again there are primary and secondary grinders. The primary grinders break the clinker down until it has the fineness of sand, and the secondary grinders pulverize the sand down to the fineness of flour, which is the final cement product ready for marketing.

7. Packaging and shipping—The final product is shipped either in bulk (ships, barges, tanker trucks, railroad cars, etc.) or in strong paper bags which are filled by machine.

Pyroprocessing and the Invention

Regardless of the type of kiln, the raw materials used to produce cement are reacted via a process known as pyroprocessing (step 5 previously described in general), where materials are subjected to high temperatures in order to bring about a chemical or physical change. In the case of manufacturing cement, pyroprocessing involves four main steps (FIG. 2):

1. Drying—Drying is accomplished by heating the raw materials to approximately 200° C., driving off water trapped in or attached to the raw materials (especially clay).

2. Heating—Heating increases the temperature of the raw materials to a temperature where other reactions can rapidly occur. The heating zone in a kiln generally brings the raw materials to 750° C.

3. Calcination—When limestone (CaCO₃) reaches approximately 900° C., it undergoes a chemical reaction called “calcination” or “calcining” in which CO₂ is released and calcium oxide is formed. Calcination is a highly energy intensive process where the main reaction is:

CaCO₃(s)+heat→CaO(s)+CO₂(g) ΔH_{f}=1.78 GJ/ton (1)

The resulting CaO is generally mixed with properly proportioned amounts of SiO₂, Al₂O₃ and possibly Fe₂O₃ and heated to partial melting, otherwise known as sintering, where additional chemical reactions occur.

4. Sintering—CaO, along with properly proportioned amounts of SiO₂, Al₂O₃ and possibly Fe₂O₃, are heated to 1450° C. and reacted via a process known as sintering. Sintering involves heating the materials to the point of partial melting; typically 30% melted. The high mobility and mixability of molten materials greatly accelerates the reaction process, increasing the reaction rate by a factor of 100 or more.

At approximately 1450° C., the major oxides from the raw materials are combined into just four cement minerals: tricalcium silicate (Ca₃SiO₅), dicalcium silicate (Ca₂SiO₄), tricalcium aluminate (Ca₃Al₂O₆) and tetracalcium aluminoferrite (Ca₄Al₂Fe₂O₁₀). Two of these four minerals, tricalcium aluminate and tetracalcium aluminoferrite, primarily exist to aid the sintering process by lowering the melting point of the mixture by 100° C. or more. The remaining two, tricalcium silicate and dicalcium silicate, are the components responsible for the strength and durability of cement and concrete. The ratios among these four minerals in typical Portland cement clinkers, and major functions of the minerals, are shown in Table 1.

Starting with raw materials at 25° C. and ending with products at 25° C., thermodynamics show that the energy required to convert raw materials into cement is 1.75 GJ/ton—over 40% less than the 3.0 GJ/ton required by a state-of-the-art facility. Achieving perfect efficiency is not possible for several reasons:

1. Suitable materials do not exist to make a perfectly insulated kiln

2. A great deal of heat is lost to combustion inefficiency, heat transfer and heat recycling losses

3. The calcination temperature of 900° C. is a “thermal bottleneck”

Of the above cited limitations, the most crucial, and the limitation the invention addresses, is the “thermal bottleneck” encountered in the pyroprocessing step described in preceding step 5. In an ideal traditional kiln, 1.55 GJ of heat energy is needed at 900° C. or above for calcination and clinker formation for a metric ton of cement, whereas only 0.20 GJ/ton of heat energy is needed below 900° C. for dehydrating and heating raw materials. In other words, the calcination temperature acts as a “thermal bottleneck” in the process; no matter how much heat is available below 900° C., it cannot be used to drive the calcination and clinker formation reactions. Therefore, a fuel is needed that burns to produce gases that are much hotter than 900° C., so that a significant proportion of the heat can be used for calcination and clinker formation.

One metric ton of good quality bituminous coal has a gross heating value of 32.6 GJ and produces 2.9 metric tons of CO₂ when burned in air. If the coal and air are initially at 25° C., only 66% of the heat energy from coal is available above 900° C., the remainder being between 25° C. and 900° C. This percentage is reduced to 60% because excess air is typically used to assure complete combustion and because rapid heat transfer from gases to solids requires a significant temperature difference. Thus, to provide 1.55 GJ/ton of heat above 900° C., a state-of-the-art cement plant needs to burn coal with a gross heating value equal to at least 2.59 GJ.

For example, consider the energy requirements attributable to the manufacture of a representative Portland cement clinker. Table 2 shows a calculation of the theoretical thermal energy requirement for the manufacture of the Portland cement clinker set out below in equation 2.

11.93CaCO₃+3.72SiO₂+0.49Al₂O₃+0.17Fe₂O₃→

2.85Ca₃SiO₅+0.87Ca₂SiO₄+0.31Ca₃Al₂O₆+0.17Ca₄Al₂Fe₂O₁₀+11.93CO₂ (2)

TABLE 2
Simplified ideal heat balance for the manufacture of Portland cement clinker

| Position in | Temperature | | Heat required |
|---|---|---|---|
| kiln system | (° C.) | Process | (kJ/kg) clinker |
| Preheater | 25-900 | Heating feed from 25° C. to 900° C. | +1475^{(a)} |
| | 100-500 | Dehydrate clay | +63 |
| | 900-25 | Captured heat cooling CO₂ from 900° C. down to 25° C. | −513^{(b)} |
| Calciner | 900 | Dissociation of calcite (CaCO3 (s) → CaO (s) + CO2 (g)) | +1974 |
| Rotary kiln | 900-1450 | Heating feed from 900° C. to 1450° C. | +544 |
| | 1450 | Formation of clinker phases | −365 |
| Clinker | 1400-900 | Captured heat from cooling of clinker from 1450° C. down to | −599 |
| cooler | | 900° C. | |
| | 900-25 | Captured heat from cooling of clinker from 900° C. down to 25° C. | −831^{(b)} |
| | | Net heat required | +1748 |
| | | Net heat required at or above the “thermal bottleneck” (900° C.) | +1554 |
| | | Net heat value of coal required at 10% excess air | +2590 |
| | | Net heat value of coal required at 10% excess air accounting | +2989(c) |
| | | for heat losses | |

^{(a)}Assumes dry limestone and clay as kiln feed.
^{(b)}It is not considered practical to recover heat from kiln exit gases below about 120° C. due to the problems engendered by the condensation of water.
(c)Heat loss from all sources estimated as 20.0% of the difference between the heat content of air at 25° C. and the heat content at a given temperature.

Starting with raw materials at 25° C. and ending with products at 25° C., the total net heat requirement for equation 2 is 1748 kJ/kg. However, achieving this efficiency is not possible in reality; suitable materials do not exist to make a perfectly insulated kiln and a great deal of heat is lost to the problems of thermal combustion efficiency, heat transfer and heat recycling. Fuel is burned in air to produce a certain volume of hot combustion gases (ideally consisting only of N₂, CO₂ and H₂O). These hot gases then transfer some of their heat to the kiln charge by radiation and convection but, clearly, this transfer can only occur when there is a significant difference in temperature between the two. As can be seen readily from Table 2, in an ideal system, a net of 1554 kJ/kg of heat are needed at temperatures above 900° C. for calcination and clinker formation in a traditional kiln, whereas a net of only 194 kJ/kg are needed below 900° C. for dehydrating and preheating raw materials.

To put it another way, the calcination temperature constitutes a “thermal bottleneck” in the process; no matter how much heat is available below that temperature, it cannot be used to drive either the calcination or the clinkering reactions. Therefore, a fuel that burns to produce gases that are much hotter than 900° C. is needed, so that a significant proportion of the heat can be used for calcination and clinker formation. One kg of good quality bituminous coal has a gross heating value of 32600 kJ and produces 2.94 kg of CO₂ when burned stoichiometrically in air. If the coal and air are initially at 25° C., approximately 66.0% of this heat is available above 900° C. (i.e., about 66.0% of the gross heating value). However, this percentage is degraded to 60% by the fact that 10% excess air is typically used to assure complete combustion and by the fact that rapid heat transfer from the gases to the solids requires a significant temperature difference. Thus, to provide a net 1554 kJ/kg clinker above 900° C., one needs to burn coal of gross heating value equal to at least 2590 kJ.

This situation is worsened by any other heat losses above 900° C. (e.g., kiln shell losses, failure to recover 100% of the heat from clinker cooler, limited residence time for heat transfer to occur, etc.). The combination of all of these factors leads to an estimate that the practical thermal efficiency limit for a perfectly tuned coal-fired cement kiln using dry raw materials is about 2989 kJ/kg relative to the theoretical requirement of 1748 kJ/kg. The discussion above, with minor variations in the specifics, also holds true for the production of calcium aluminate cements.

### SUMMARY OF THE INVENTION

Accordingly, it is an object of the present invention to provide a means for producing calcium silicates, calcium aluminates and calcium aluminosilicates more energy efficiently than is possible in a typical cement kiln or other common manufacturing process.

It is yet another object of the present invention to provide a means for producing calcium silicates, calcium aluminates and calcium aluminosilicates at lower temperatures than those required in a typical cement kiln or other common manufacturing process.

It is yet another object of the present invention to provide a means for producing calcium silicates, calcium aluminates and calcium aluminosilicates from source materials containing impurities such as mercury, lead, cadmium, antimony, sodium, potassium and chlorine while also safely and cost effectively removing those impurities.

It is yet another object of the present invention to provide a means for safely and cost effectively removing impurities such as mercury, lead, cadmium, antimony, sodium, potassium and chlorine from calcium silicates, calcium aluminates and calcium aluminosilicates during the production or processing of said calcium silicates, calcium aluminates and calcium aluminosilicates.

It is yet another object of the present invention to provide a means for decreasing the required residence time of reactants in a cement kiln, thereby increasing the production capacity of a cement kiln.

These and other objects, advantages and features of the invention will be set forth in the summary and the detailed description which follows.

The present invention overcomes the aforementioned “thermal bottleneck” by utilizing molten-salt synthesis and/or molten-salt sintering (hereinafter “molten salt synthesis”) to provide a catalyzing medium or flux for CaCO₃, SiO₂, Al₂O₃ and other related compounds at temperatures significantly below the temperatures commonly in use today. Molten-salt synthesis is one of the most versatile, and cost-effective approaches available for obtaining crystalline-phase powders at lower temperatures, often in overall shorter reaction times as compared with conventional solid-state and clinkering (sintering in the presence of partial melt) reactions. The appeal of this technique arises from its intrinsic scalability, general applicability, and utility. In the present invention, the molten salt medium or flux lowers the melting point of CaCO₃ below the decarbonation temperature of CaCO₃, resulting in partial or completely molten CaCO₃. Molten CaCO₃ quickly and energy efficiently interacts with SiO₂ and Al₂O₃, bypassing the energy-intensive step of creating CaO through decarbonation and forming micro-particles of the desired product or products at substantially lower temperatures than are practicable in solid-state or clinkering reactions.

The selection of an appropriate reaction medium is related to the success of molten-salt synthesis. Among the factors that drive the selection of reaction medium are 1) viscosity, 2) density, 3) melting point, 4) vaporization pressure, 5) ability to depress the melting point of CaCO₃, 6) potential chemical interactions with reactants, atmosphere and container, 7) cost, and 8) general environmental risk. While not an exhaustive list, several potential reaction medium salts are presented in Table 3.

TABLE 3
Partial list of potential molten salt medium compounds

| | Density | Density | | | | Ability to | |
|---|---|---|---|---|---|---|---|
| | at | at | Melting | Boiling | Typical | depress | |
| | 25° C. | 600° C. | Point | Point | Viscosity | melting | Stability |
| Compound | (gm/cm³) | (gm/cm³) | (° C.) | (° C.) | (centipose) | point | in air |
| Cadmium Chloride | 4.08 | 3.37 | 568 | 964 | 2-3 | ✓ | ✓ |
| Cadmium Bromide | 5.03 | 4.04 | 568 | 863 | 2-3 | ✓ | X |
| Calcium Bromide | 3.35 | 3.18 | 730 | 1935 | 3-5 | ✓ | X |
| Calcium Chloride | 2.15 | 2.15 | 772 | 1935 | 3-5 | ✓ | ✓ |
| Calcium Iodide | 3.96 | 3.58 | 740 | 1100 | 3-6 | ✓ | X |
| Cesium Chloride | 3.99 | 2.85 | 645 | 1297 | 1-2 | ✓ | ✓ |
| Cesium Bromide | 4.44 | 3.19 | 636 | 1300 | 1-2 | ✓ | ✓ |
| Copper(I) Chloride | 4.15 | 3.56 | 426 | 1490 | 2-3 | ✓ | ✓ |
| Copper(I) Bromide | 4.71 | 4.05 | 492 | 1345 | 3-5 | ✓ | ✓ |
| Iron (II) Bromide | 4.63 | 3.87 | 684 | 934 | 4-6 | ✓ | X |
| Lithium Carbonate | 2.11 | 1.82 | 723 | 1310 | 3-5 | X | ✓ |
| Lithium Chloride | 2.07 | 1.51 | 605 | 1382 | 3-5 | ✓ | X |
| Lithium Bromide | 3.46 | 2.50 | 552 | 1265 | 2-4 | ✓ | ✓ |
| Lithium Nitrate | 2.38 | 1.59 | 225 | 723 | 2-4 | X | X |
| Lead Chloride | 5.98 | 4.80 | 501 | 951 | 4-6 | ✓ | ✓ |
| Lead Bromide | 6.69 | 5.35 | 371 | 892 | 4-6 | ✓ | ✓ |
| Manganese Chloride | 2.98 | 2.37 | 650 | 1190 | 3-5 | X | ✓ |
| Manganese Bromide | 4.39 | 3.49 | 698 | 1027 | 3-5 | ✓ | X |
| Potassium Bromide | 2.75 | 2.24 | 734 | 1435 | 2-4 | X | ✓ |
| Potassium Chloride | 1.98 | 1.63 | 790 | 1420 | 2-4 | X | ✓ |
| Potassium Iodide | 3.12 | 2.53 | 681 | 1330 | 3-6 | X | X |
| Silver Chloride | 5.56 | 4.75 | 455 | 1547 | 2-3 | ✓ | ✓ |
| Silver Bromide | 6.47 | 5.41 | 432 | 1502 | 2-3 | ✓ | ✓ |
| Sodium Bromide | 3.21 | 2.46 | 774 | 1396 | 3-4 | X | ✓ |
| Sodium Carbonate | 2.54 | 2.09 | 851 | 1600 | 2-4 | X | ✓ |
| Sodium Chloride | 2.17 | 1.66 | 801 | 1413 | 3-5 | ✓ | ✓ |
| Sodium Iodide | 3.67 | 2.80 | 661 | 1304 | 4-6 | ✓ | X |
| Strontium Bromide | 4.22 | 3.74 | 643 | 2146 | 3-5 | ✓ | ✓ |
| Strontium Chloride | 3.05 | 2.89 | 874 | 1250 | 3-5 | X | ✓ |
| Strontium Iodide | 5.46 | 4.03 | 538 | 1773 | 4-6 | ✓ | X |
| Zinc Bromide | 4.22 | 3.28 | 394 | 698 | 250+ | ✓ | X |

| | | | | | | Reasonable |
|---|---|---|---|---|---|---|
| | | | | | Relatively | ability to |
| | Stability | Stability | Stability | | Low | mitigate |
| | vs. | vs. | vs. | | Environmental | environmental |
| Compound | SiO₂ | Al₂O₃ | Kaolin | Cost | Risk | risk |
| Cadmium Chloride | ✓ | ✓ | ✓ | ✓ | X | X |
| Cadmium Bromide | ✓ | ✓ | ✓ | ✓ | X | X |
| Calcium Bromide | X | X | X | ✓ | ✓ | ✓ |
| Calcium Chloride | ✓ | ✓ | ✓ | ✓ | ✓ | ✓ |
| Calcium Iodide | X | X | X | X | X | ✓ |
| Cesium Chloride | ✓ | ✓ | ✓ | X | X | ✓ |
| Cesium Bromide | ✓ | ✓ | ✓ | X | X | ✓ |
| Copper(I) Chloride | ✓ | X | X | ✓ | ✓ | ✓ |
| Copper(I) Bromide | ✓ | ✓ | ✓ | ✓ | ✓ | ✓ |
| Iron (II) Bromide | ✓ | X | X | ✓ | ✓ | ✓ |
| Lithium Carbonate | X | X | X | ✓ | ✓ | ✓ |
| Lithium Chloride | ✓ | X | ✓ | ✓ | ✓ | ✓ |
| Lithium Bromide | ✓ | X | ✓ | ✓ | ✓ | ✓ |
| Lithium Nitrate | ✓ | X | ✓ | ✓ | X | ✓ |
| Lead Chloride | ✓ | X | ✓ | ✓ | X | ✓ |
| Lead Bromide | ✓ | ✓ | ✓ | ✓ | X | ✓ |
| Manganese Chloride | X | X | X | ✓ | ✓ | ✓ |
| Manganese Bromide | X | X | X | ✓ | ✓ | ✓ |
| Potassium Bromide | ✓ | ✓ | ✓ | ✓ | ✓ | ✓ |
| Potassium Chloride | ✓ | ✓ | ✓ | ✓ | ✓ | ✓ |
| Potassium Iodide | X | ✓ | ✓ | X | ✓ | ✓ |
| Silver Chloride | ✓ | ✓ | ✓ | X | ✓ | ✓ |
| Silver Bromide | ✓ | ✓ | ✓ | X | ✓ | ✓ |
| Sodium Bromide | ✓ | ✓ | ✓ | ✓ | ✓ | ✓ |
| Sodium Carbonate | X | ✓ | ✓ | ✓ | ✓ | ✓ |
| Sodium Chloride | ✓ | ✓ | ✓ | ✓ | ✓ | ✓ |
| Sodium Iodide | X | ✓ | ✓ | X | ✓ | ✓ |
| Strontium Bromide | X | X | X | ✓ | ✓ | ✓ |
| Strontium Chloride | ✓ | ✓ | ✓ | ✓ | ✓ | ✓ |
| Strontium Iodide | X | X | X | X | ✓ | ✓ |
| Zinc Bromide | ✓ | X | X | ✓ | ✓ | ✓ |

(a) Many molten salts may be used in combination to achieve the desired reaction medium properties. It has been observed that salt mediums containing at least a minor fraction of calcium-based salt generally enhances the stability of the salt medium with respect to the reactants.

In example embodiments of the invention described herein, the reaction medium used is either a mixed salt medium of LiCl—CaCl₂, CuCl—CaCl₂ or PbCl₂—CaCl₂. As shown in FIGS. 3, 4 and 5, LiCl—CaCl₂ and PbCl₂—CaCl₂ have eutectic points under 500° C. and low viscosities, allowing the reaction medium and reactants to freely mix. LiCl—CaCl₂, CuCl—CaCl₂ and PbCl₂—CaCl₂ also have low vapor pressures and can be effectively recycled, making them significantly less harmful to the environment than many alternative salts. LiCl—CaCl₂, CuCl—CaCl₂ and PbCl₂—CaCl₂ are also moderately priced. Furthermore, CuCl—CaCl₂ and PbCl₂—CaCl₂ have higher densities than the calcium silicates, calcium aluminates and calcium aluminosilicates being produced (Table 4), allowing the calcium silicates, calcium aluminates and calcium aluminosilicates to float to the surface of the melt where they can be removed by low cost mechanical means. All potential molten salt mediums are also candidates for fluxes in molten salt sintering.

TABLE 4
Physical attributes of calcium silicates and related compounds

| | Density at 25° C. | |
|---|---|---|
| Compound | (gm/cm³) | Relative Hydraulic Activity |
| CaSiO₃ | 2.92 | Poorly hydraulic. |
| γ-Ca₂SiO₄ | 2.97 | Poorly hydraulic. |
| β-Ca₂SiO₄ | 3.31 | Slow to good hydraulic activity. Excellent long term strength. |
| α′_{H}-Ca₂SiO₄ | 2.94 | Good to excellent hydraulic activity. Excellent long term strength. |
| Ca₃Sᵢ₂O₇ | 2.99 | Poorly hydraulic. |
| Ca₃SiO₅ | 3.15 | Excellent hydraulic activity and strength. Good extendibility with |
| | | siliceous additions. |
| Ca₃Al₂O₆ | 3.04 | Excellent hydraulic activity. Imparts negligible strength in Portland |
| | | cement. |
| CaAl₂O₄ | 2.98 | Excellent hydraulic activity. Primary compound in Cement Fondue. |
| CaAl₄O₇ | 2.91 | Excellent hydraulic activity. |
| Ca₄Al₂Fe₂O₁₀ | 3.73 | Good to excellent hydraulic activity. Imparts negligible strength. |
| Al₂O₃ | 3.97 | Non-hydraulic. |
| Fe₂O₃ | 5.25 | Non-hydraulic. |

Processing steps and utilization of the described materials, elements and compounds are set forth in the following detailed description along with various examples of mechanisms, apparatus, vessels and kiln structure designed to practice the invention.

### BRIEF DESCRIPTION OF THE DRAWING

In the detailed description which follows, reference is made to the following figures:

FIG. 1 is a flow diagram overview of the cement manufacturing process;

FIG. 2 is a diagram of the functional zones for common kiln technologies;

FIG. 3 is a phase diagram of CaCl₂—CaCO₃;

FIG. 4 is a phase diagram of LiCl—CaCl₂;

FIG. 5 is a phase diagram of PbCl₂—CaCl₂;

FIG. 6 is an x-ray diffraction result from the introduction of equal molar quantities of CaCO₃ and SiO₂ into a molten salt medium of LiCl—CaCl₂ at 600° C. for 1 hour in an unstirred Al₂O₃ crucible. All peaks correspond to Wollastonite (CaSiO₃). Identical results were achieved in an unstirred platinum crucible at 600° C. for 1 hour;

FIGS. 7-9 are flow diagrams illustrating the process steps for various embodiments of the invention;

FIG. 10 is a simplified process diagram for manufacture of cement using a salt melt to generate Ca₂SiO₄

FIG. 11 is a flow diagram illustrating the process steps for one of the various embodiments of the invention;

FIG. 12 is an x-ray diffraction result from the introduction of 3:2 molar quantities of CaCO₃ and SiO₂ into a molten salt medium of LiCl—CaCl₂ at 650° C. for 4 hours in an unstirred platinum crucible. All major peaks correspond to Rondorfite (Ca₈Mg(SiO₄)₄Cl₂), Monticellite (Ca₃MgSi₂O₄), Wollastonite (CaSiO₃) and Calcite (CaCO₃);

FIG. 13 is an x-ray diffraction result from the introduction of approximately equal molar quantities of CaCO₃ and Kaolinite (Al₂Si₂O₅(OH)₄) into a molten salt medium of LiCl—CaCl₂ at 625° C. for 1 hour in an unstirred Al₂O₃ crucible. All major peaks correspond to Gehlenite (Ca₂Al₂SiO₇), Grossular (Ca₃Al₂(SiO₄)₃), and Mayenite (Ca₁₂Al₁₄O₃₃). CaSiO₃ is not present due to the calcium-poor nature of the reactants and the formation of Grossular (moles Al₂Si₂O₅(OH)₄>moles CaCO₃).;

FIGS. 14-15 are flow diagrams illustrating the process steps for various embodiments of the invention;

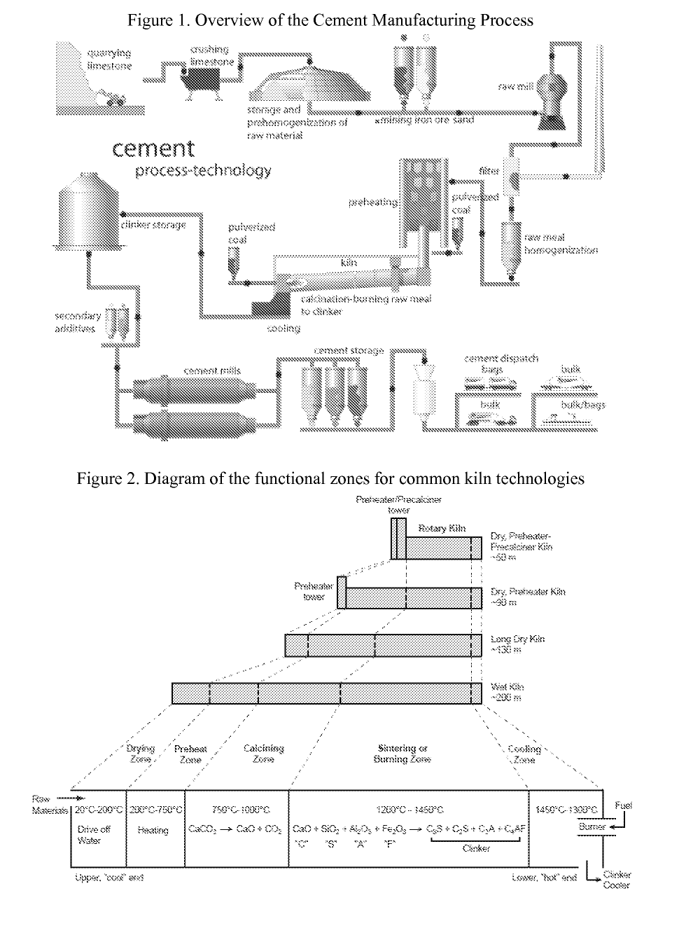

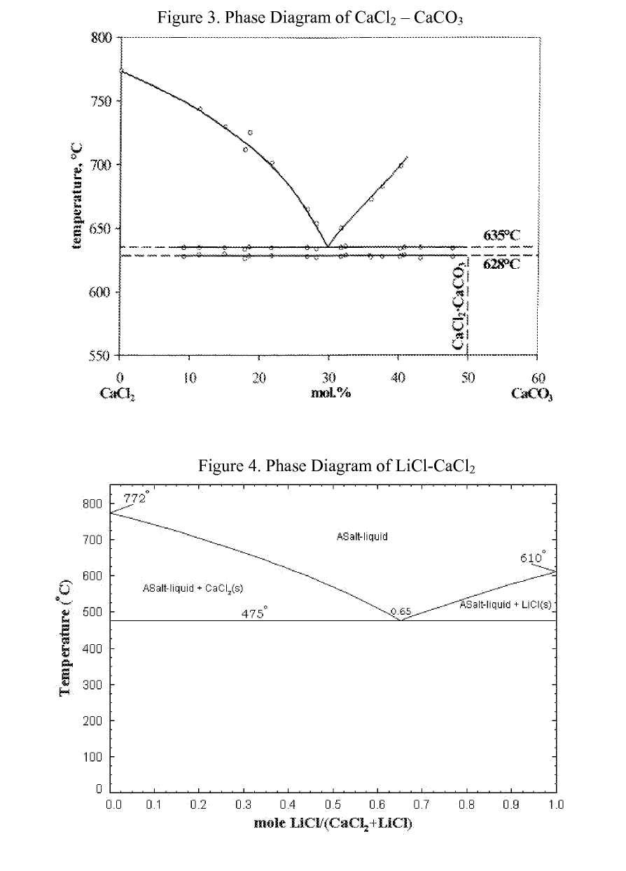

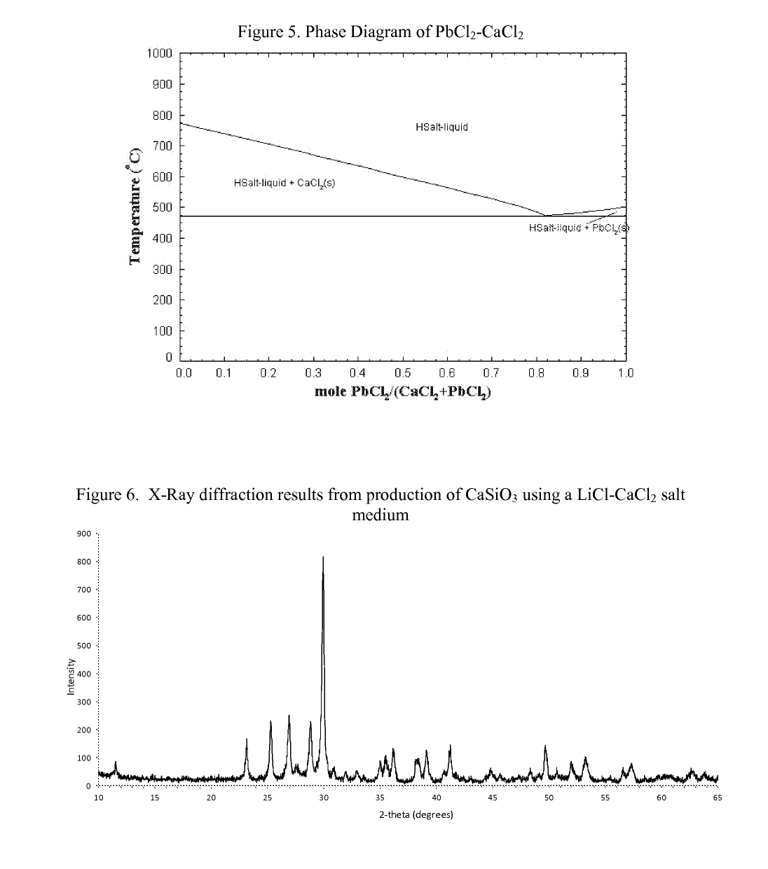

### DETAILED DESCRIPTION OF EMBODIMENTS OF THE INVENTION

The embodiments of the invention can be divided into two major categories: A) embodiments based on CaCO₃ and SiO₂ and B) embodiments based on CaCO₃ and clay containing primarily SiO₂ and Al₂O₃. Regardless, of the embodiment, impurities such as MgO, Li₂O and PbO may have an impact on the compounds formed; care must be taken to minimize or counterbalance impurities that may result in the production of Alinite, Belinite, Monticellite and other compounds that could result from an adverse interaction with the molten salt medium or might be preferentially formed with the reactants. The inclusion of CaCl₂ in the salt medium (60%>CaCl₂>0%) has proven extremely useful in avoiding the formation of undesirable oxides but can lead to the formation of Alinite. Likewise, reactions using clay containing SiO₂ and Al₂O₃ instead of a source primarily containing SiO₂ necessitates accounting for the multitude of potential aluminate and aluminosilicate products and any impact they may have upon the melt reaction and eventual hydration. Additionally, any process and mixture of starting materials must also account for the corrosive nature of the salt melt, particularly in regards to steel containment vessels.

A. Embodiments based on CaCO₃ and SiO₂

The embodiments of the invention based on CaCO₃ and SiO₂ can be divided into two major sub-categories: 1) embodiments for the production of CaSiO₃, and 2) embodiments for the production of Ca₂SiO₄.

1) Embodiment to produce CaSiO₃

An embodiment to produce CaSiO₃ utilizes a molten salt medium to support a direct interaction between molten CaCO₃ and SiO₂ according to equations (2-4). Three examples of salt mediums for this embodiment are LiCl—CaCl₂, PbCl₂—CaCl₂, and CuCl—CaCl₂. In the case of any reaction medium, properly proportioned amounts of CaCO₃ become molten in the salt medium. The reaction, which is favorable even below the eutectic temperature of the salt medium, proceeds rapidly with a molten reactant as demonstrated by the pure substance calculations presented in Table 5. X-ray diffraction results from experiments using a LiCl—CaCl₂ salt medium are presented in FIG. 6 and show the formation of pure CaSiO₃.

TABLE 5
Thermodynamic equations for production of CaSiO₃

| | | Enthalpy of | Gibbs Energy of | Equation |
|---|---|---|---|---|
| Temperature | Reaction Equation | Formation | Formation | Number |
| At 25° C.: | CaCO₃ (s) + SiO₂ (s) → CaSiO₃ (s) + CO₂ (g) | ΔH_{f} = +89.0 kJ/mol | ΔG_{f} = +40.6 kJ/mol | (3) |
| At 300° C.: | CaCO₃ (s) + SiO₂ (s) → CaSiO₃ (s) + CO₂ (g) | ΔH_{f} = +86.4 kJ/mol | ΔG_{f} = −3.3 kJ/mol | (4) |
| At 500° C.: | CaCO₃ (l) + SiO₂ (s) → CaSiO₃ (s) + CO₂ (g) | ΔH_{f} = +65.1 kJ/mol | ΔG_{f} = −60.5 kJ/mol | (5) |

(3) ΔG_{f} shows the equation is not favorable and does not proceed
(4) ΔG_{f} shows the equation is favorable, but the solid-solid interaction between the reactants would be very slow
(5) ΔG_{f} shows the equation is favorable and the liquid-solid interaction between the reactants is fast

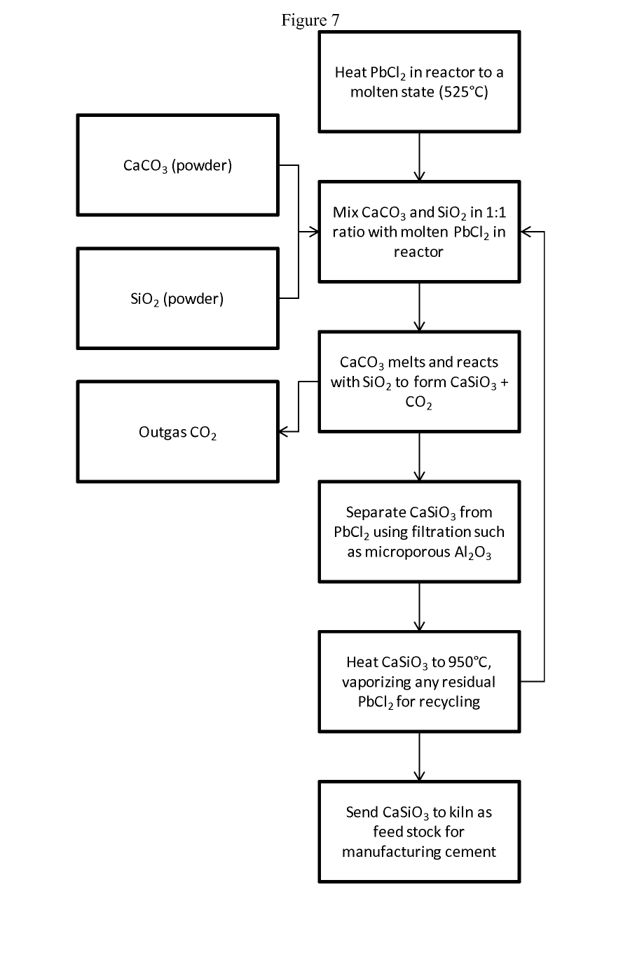

The Reactor of the Invention is not expected to replace the modern cement kiln, preheater or precalciner. Rather, the Reactor is envisioned as a pre-processor for a portion of the kiln feed. More specifically, a portion of the crushed limestone, along with all of the silica, alumina and ferrite, would be sent to the Reactor instead of the precalciner to form calcium silicates, calcium aluminates and possibly calcium ferrites (the “Precursor Minerals”) at a temperature between 400° C. and 600° C. Ideally the molten salt would be of low viscosity and high density, causing the Precursor Minerals to float to the surface of the melt upon formation. The Precursor Minerals could be separated from the molten salt via a mechanical scooping, skimming or filtering means with additional purification possible via the application of centrifugal force or through vaporization of the salt as a by-product of heating the Precursor Minerals for introduction into the kiln. An example of the envisioned Reactor utilizing a salt melt of PbCl₂ to produce CaSiO₃ cement precursors is as follows (FIG. 7):

1. A PbCl₂ salt bath is heated to melting in a container made of Al₂O₃ or possibly MgAl₂O₄. PbCl₂ melts by itself at 501° C., so there is no danger of solidification at approximately 525° C. The density of the salt bath is estimated at 4.92 g/cm³ with a viscosity of less than 4.0 centipose. Because of the moderate temperatures required, use of “waste heat”, typically exhaust from the kiln or precalciner, along with renewable or green heat sources is possible.

2. CaCO₃ and SiO₂ (most likely as limestone and silica) are mixed and heated to 525° C. in a 1:1 ratio.

3. The heated raw materials are introduced into the salt bath or mix with PbCl₂ as a sintering fluid, where the limestone becomes at least partially liquid and reacts with the silica to release CO₂ to form CaSiO₃. Ca₂SiO₄, along with other minerals, may also be formed depending on the ratio of the raw materials placed into the salt bath.

4. Sodium and Potassium will become chloride salts, converting lead chloride into lead oxide. A small amount of lead oxide will not adversely impact the resulting cement, but impurity levels in the salt bath will require monitoring over time and can be countered by the addition of small amounts of calcium chloride, leading to the creation of calcium oxide and lead chloride.

5. Chloride and bromide impurities from the raw materials, possibly including coal ash, will remain in the salt bath as the temperature of the bath is high enough to cause them to melt but not so high as to result in vaporization.

6. Unlike CaCO₃, the mineral CaSiO₃ does not melt in the salt bath and therefore will float to the surface (the density of CaSiO₃ is substantially lower than the salt bath).

7. CaSiO₃ is primarily separated from the salt bath via a small pore size (typically less than 10 um), high porosity filter made of Al₂O₃ or MgAl₂O₄.

8. Molten salt sticking to the surface of the CaSiO₃ is removed through the vaporization of any remaining PbCl₂ at 950° C., returning the salt to the salt bath.

9. Exhaust fumes can be further filtered through water containing trace amounts of Ca(OH)₂ or another appropriate salt that will interact with any remaining PbCl₂, resulting in the creation extremely insoluble and easily recoverable Pb(OH)₂. The water used to capture any residual lead is easily filtered using low-cost commercially available water filtration technology. Filtering of this sort should result in virtually 100% containment and recycling of lead containing compounds.

10. CaSiO₃ is sent into the kiln to interact with CaO from the precalciner, forming clinker nodules of portland cement using traditional cement making methods.

A similar implementation is contemplated for production of alumino-silicate cements, calcium sulfo-aluminate cements, calcium sulfate cements and fly ash substitute (should the demand for fly ash exceed availability).

CaSiO₃ produced using the method disclosed herein can be used as feedstock for the production of alpha/beta-Ca₂SiO₄ and Ca₃SiO₅ in a traditional kiln, thereby significantly reducing the “thermal bottleneck”. As shown in Table 6 below, using a salt melt to produce CaSiO₃ reduces the size of the “thermal bottleneck” at 900° C., resulting in a 17.6% reduction in energy consumption and 7.6% reduction in CO₂ emissions versus the traditional kiln with precalciner process (accounting for CO₂ from both calcination and burning coal).

TABLE 6
Simplified ideal heat balance using a salt melt to generate CaSiO₃

| Position in | Temperature | | Heat required |
|---|---|---|---|
| kiln system | (° C.) | Process | (kJ/kg) clinker |
| Preheater | 25-500 | Heating feed from 25° C. to 500° C. | +736^{(a)} |
| | 100-500 | Dehydrate clay | +63 |
| Salt Melt | 500 | Creation of calcium silicate in melt | +309 |
| | | (CaCO₃ (s) + SiO₂ (s) → CaSiO₃ (s) + CO₂ (g)) | |
| Calciner | 500-900 | Heating feed from 500° C. to 900° C. | +624 |
| | 900 | Dissociation of remaining calcite (CaCO₃ (s) → CaO (s) + CO₂ (g)) | +1358 |
| | 900-500 | Captured heat of generated CO₂ cooling from 900° C. down to 500° C. | −177 |
| Rotary kiln | 900-1450 | Heating feed from 900° C. to 1450° C. | +575 |
| | 1450 | Formation of clinker phases | −55 |
| Clinker cooler | 1450-900 | Captured heat from cooling of clinker from 1450° C. down to 900° C. | −599 |
| | 900-500 | Captured heat from cooling of clinker from 900° C. down to 500° C. | −413 |
| | 500-25 | Captured heat from cooling of clinker from 500° C. down to 25° C. | −418^{(b)} |
| | 500-25 | Captured heat of generated CO₂ cooling from 500° C. down to 25° C. | −255^{(b)} |
| | | Net heat required | +1748 |
| | | Net heat required at or above “thermal bottleneck” (900° C.) | +1276 |
| | | Net heat value of coal required at 10% excess air | +2134 |
| | | Net heat value of coal required at 10% excess air accounting for heat | +2462^{(c)} |
| | | losses | |

^{(a)}Assumes dry limestone and clay as kiln feed.
^{(b)}It is not considered practical to recover heat from kiln exit gases below about 120° C. due to the problems engendered by the condensation of water.
^{(c)}Heat loss from all sources estimated as 20.0% of the difference between the heat content of air at 25° C. and the heat content at a given temperature.

Another embodiment to produce CaSiO₃

An embodiment to produce CaSiO₃ utilizes a molten salt medium to support an indirect interaction between molten CaCO₃ and SiO₂ according to equations (6-8). Three examples of salt mediums for this embodiment are ZnBr₂, FeBr₂, and CuCl. In the case of these reaction mediums, properly proportioned amounts of CaCO₃ react with the salt medium to produce CaX₂, CO₂ and YO (X═Br, Br, Cl and Y═Zn, Fe, Cu₂, respectively). These reactions typically require an atmosphere devoid of 0₂ in order to avoid undesirable side-reactions. The reaction proceeds rapidly with a molten reactant as demonstrated by the pure substance calculations presented in Table 7.

TABLE 7
Thermodynamic equations for production of CaSiO₃ using ZnBr₂

| | | Enthalpy of | Gibbs Energy of | Equation |
|---|---|---|---|---|
| Temperature | Reaction Equation | Formation (ΔH_{f}) | Formation (ΔG_{f}) | Number |
| At 500° C.: | ZnBr₂ (l) + CaCO₃ (s) → ZnO (s) + CO₂ (g) + | +89.1 kJ/mol | −7.4 kJ/mol | (6) |
| | CaBr₂ (l) | | | |
| At 750° C.: | ZnO (l) + CaBr₂ (l) + SiO₂ (s) → CaSiO₃ (s) + | −6.0 kJ/mol | −26.8 kJ/mol | (7) |
| | ZnBr₂ (l) | | | |
| | ZnBr₂ (l) → ZnBr₂ (g) | +111.0 kJ/mol | −5.4 kJ/mol | (8) |

(6-7) ΔG_{f} shows the equation is favorable and the liquid-solid interaction between the reactants should proceed quickly
(8) ΔG_{f} shows the catalyst can be removed viavaporization and recycled

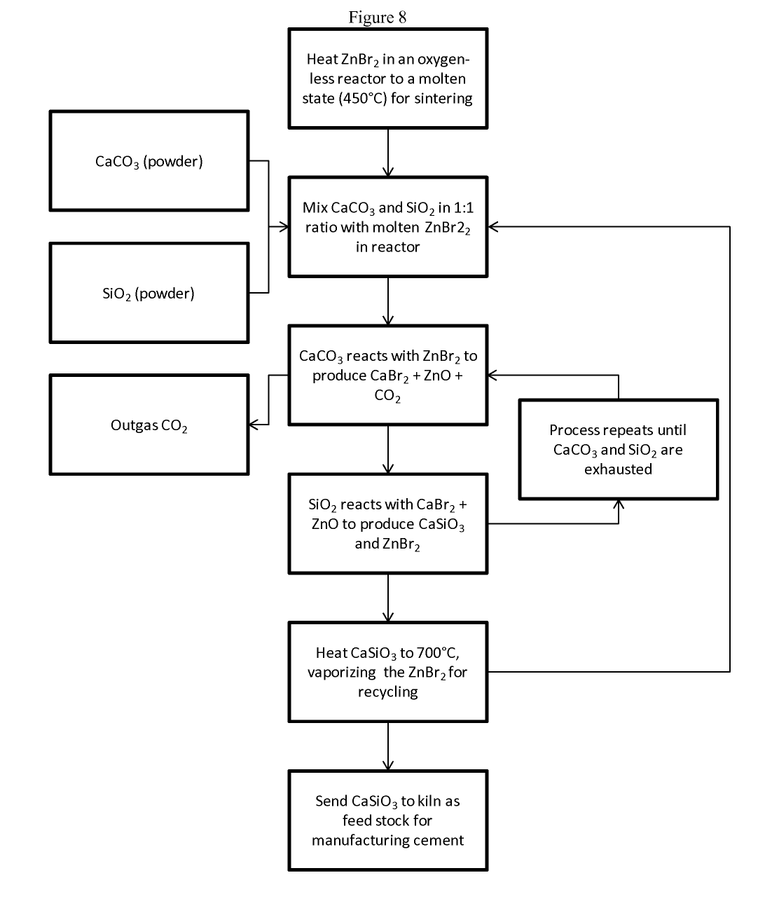

An example of the envisioned Reactor utilizing a salt melt of ZnBr₂ to produce CaSiO₃ cement precursors is as follows (FIG. 8):

1. A ZnBr₂ salt bath is heated to melting in an inert or 100% CO₂ atmosphere container made of Al₂O₃ or possibly MgAl₂O₄. ZnBr₂ melts by itself at 394° C., so there is no danger of solidification at approximately 450° C. The density of the salt bath is estimated at 3.42 g/cm³ with a viscosity in excess of 300 centipose. Because of the moderate temperatures required, use of “waste heat”, typically exhaust from the kiln or precalciner, along with renewable or green heat sources is possible.

2. CaCO₃ and SiO₂ (most likely as limestone and silica) are mixed and heated to 450° C. in a 1:1 ratio.

3. The heated raw materials are introduced into the salt bath or mix with ZnBr₂ as a sintering fluid, where the limestone reacts with the zinc bromide to form CaBr₂ and ZnO with the release of CO₂.

4. Molten CaBr₂ and ZnO react with SiO₂ to produce CaSiO₃ and ZnBr₂. The reconstituted ZnBr₂ becomes available to repeat step 3 until the sources of CaCO₃ and SiO₂ are exhausted.

5. Thermodynamics indicate that Al₂O₃ cannot be used in conjunction with ZnBr₂.

6. Sodium and Potassium will become bromide salts, converting zinc bromide into zinc oxide. A small amount of zinc oxide will not adversely impact the resulting cement, but impurity levels in the salt bath will require monitoring over time and can be countered by the addition of small amounts of calcium bromide plus silica, leading to the creation of CaSiO₃ and ZnBr₂.

7. Chloride and bromide impurities from the raw materials, possibly including coal ash, will remain in the salt bath as the temperature of the bath is high enough to cause them to melt but not so high as to result in vaporization.

8. Unlike CaCO₃, the mineral CaSiO₃, will not melt in or react with the salt bath and therefore will float to the surface (the density of CaSiO₃ is substantially lower than the salt bath).

9. Molten salt sticking to the surface of the CaSiO₃ is removed through the vaporization of any remaining ZnBr ₂ at 698° C., returning the salt to the salt bath.

10. Exhaust fumes can be further filtered through water containing trace amounts of Ca(OH)₂ or another appropriate salt that will interact with any remaining ZnBr ₂, resulting in the creation extremely insoluble and easily recoverable Zn(OH)₂. The water used to capture any residual zinc is easily filtered using low-cost commercially available water filtration technology. Filtering of this sort should result in virtually 100% containment and recycling of zinc containing compounds.

11. CaSiO₃ is sent into the kiln to interact with CaO from the precalciner, forming clinker nodules of portland cement using traditional cement making methods.

CaSiO₃ produced using the method disclosed herein can be used as feedstock for the production of alpha/beta-Ca₂SiO₄ and Ca₃SiO₅ in a traditional kiln, thereby significantly reducing the “thermal bottleneck”. Once the reaction is complete, the salt medium can be removed and recycled through vaporization. As shown in Table 6 above, using a salt melt to produce CaSiO₃ reduces the size of the “thermal bottleneck” at 900° C., resulting in a 17.6% reduction in energy consumption and 7.6% reduction in CO₂ emissions versus the traditional kiln with precalciner process (accounting for CO₂ from both calcination and burning coal). Depending on the salt medium selected, the salt and reaction products may be separated using a variety of techniques including but not necessarily limited to vaporization, density separation or dissolution in a solvent.

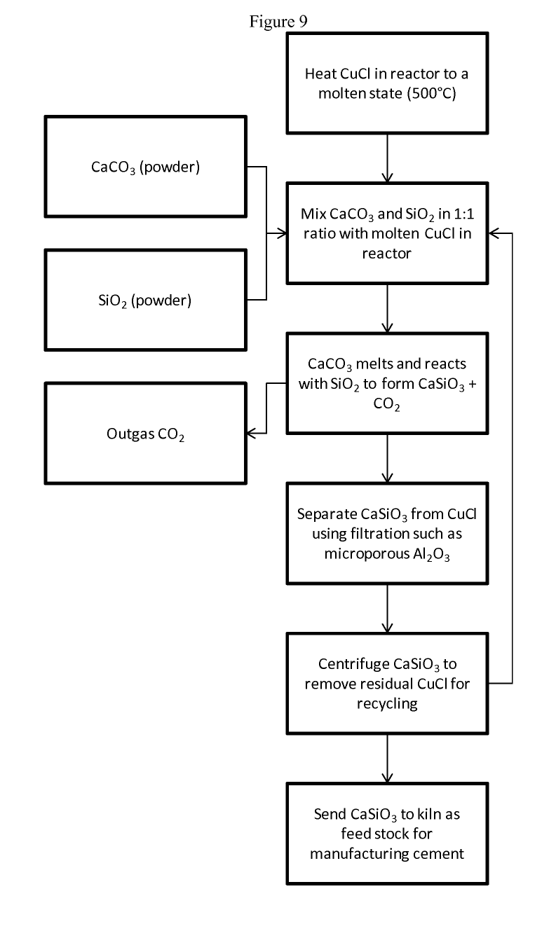

Another example of the envisioned Reactor utilizing a salt melt of CuCl to produce CaSiO₃ cement precursors is as follows (FIG. 9):

1. A CuCl salt bath is heated to melting in a container made of Al₂O₃ or possibly MgAl₂O₄. CuCl melts by itself at 426° C., so there is no danger of solidification at approximately 500° C. The density of the salt bath is estimated at 3.63 g/cm³ with a viscosity of less than 3.0 centipose. Because of the moderate temperatures required, use of “waste heat”, typically exhaust from the kiln or precalciner, along with renewable or green heat sources is possible.

2. CaCO₃ and SiO₂ (most likely as limestone and silica) are mixed and heated to 500° C. in a 1:1 ratio.

3. The heated raw materials are introduced into the salt bath or mix with CuCl as a sintering fluid, where the limestone becomes at least partially liquid and reacts with the kaolinite to release CO₂ to form CaSiO₃. Ca₂SiO₄, along with other minerals, may also be formed depending on the ratio of the raw materials placed into the salt bath.

4. Sodium and Potassium will become chloride salts, converting copper chloride into copper oxide. A small amount of copper oxide will not adversely impact the resulting cement, but impurity levels in the salt bath will require monitoring over time and can be countered by the addition of small amounts of calcium chloride, leading to the creation of calcium oxide and copper chloride.

5. Chloride and bromide impurities from the raw materials, possibly including coal ash, will remain in the salt bath as the temperature of the bath is high enough to cause them to melt but not so high as to result in vaporization.

6. Unlike CaCO₃, the mineral CaSiO₃ does not melt in the salt bath and therefore will float to the surface (the density of CaSiO₃ is substantially lower than the salt bath).

7. CaSiO₃is primarily separated from the salt bath via a small pore size (typically less than 10 um), high porosity filter made of Al₂O₃ or MgAl₂O₄.

8. Molten salt sticking to the surface of the CaSiO₃ is removed through the application of centripetal force, returning the salt to the salt bath.

9. CaSiO₃ is sent into the kiln to interact with CaO from the precalciner, forming clinker nodules of portland cement using traditional cement making methods.

A similar implementation is contemplated for production of alumino-silicate cements, calcium sulfo-aluminate cements, calcium sulfate cements and fly ash substitute (should the demand for fly ash exceed availability).

CaSiO₃ produced using the method disclosed herein can be used as feedstock for the production of alpha/beta-Ca₂SiO₄ and Ca₃SiO₅ in a traditional kiln, thereby significantly reducing the “thermal bottleneck”.

2) Embodiment to produce Ca₂SiO₄

An embodiment to produce Ca₂SiO₄ utilizes a molten salt medium to support a direct interaction between molten CaCO₃ and SiO₂ according to equations (6-9). Two examples of salt mediums for this embodiment are LiCl—CaCl₂ and PbBr₂. In the case of the PbBr₂ reaction medium, CaCO₃ becomes molten at temperatures as low as 400° C., while the reactions are favorable at temperatures of approximately 500° C. and proceed rapidly as demonstrated by the pure substance calculations in Table 8.

TABLE 8
Thermodynamic equations for production of Ca₂SiO₄

| | | Enthalpy of | Gibbs Energy of | Equation |
|---|---|---|---|---|
| Temperature | Reaction Equation | Formation | Formation | Number |
| At 25° C.: | CaCO₃ (s) + SiO₂ (s) → CaSiO₃ (s) + CO₂ (g) | ΔH_{f} = +89.0 kJ/mol | ΔG_{f} = +40.6 kJ/mol | (9) |
| | CaCO₃ (s) + CaSiO₃ (s) → Ca₂SiO₄ (s) + CO₂ (g) | ΔH_{f} = +132.9 kJ/mol | ΔG_{f} = +83.3 kJ/mol | (10) |
| At 500° C.: | CaCO₃ (l) + SiO₂ (s) → CaSiO₃ (s) + CO₂ (g) | ΔH_{f} = +65.1 kJ/mol | ΔG_{f} = −60.5 kJ/mol | (11) |
| | CaCO₃ (l) + CaSiO₃ (s) → Ca₂SiO₄ (s) + CO₂ (g) | ΔH_{f} = +125.8 kJ/mol | ΔG_{f} = +0.6 kJ/mol | (12) |

(9-10) ΔG_{f} shows the equations are not favorable and do not proceed
(11-12) Shows equations where a liquid-solid interaction between the reactants could proceed rapidly if ΔG_{f} < 0. ΔG_{f} = 0.0 kJ/mol at 504° C. and ΔG_{f} = −0.88 jK/mol at 510° C., but Table 7 presents 500° C. for ease of comparison with the other embodiments.

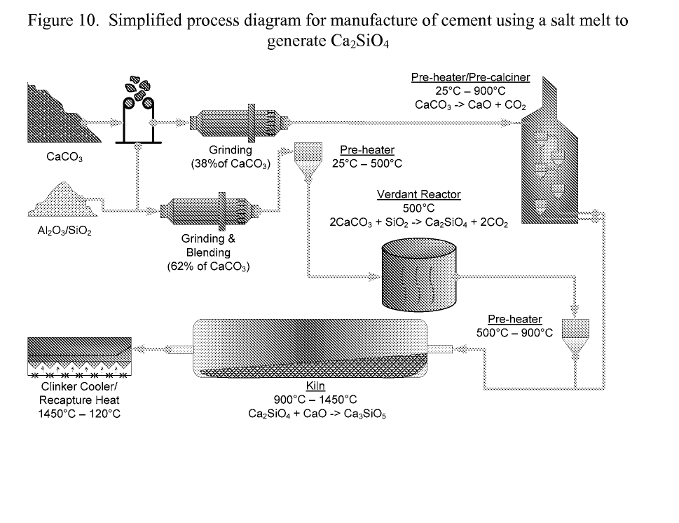

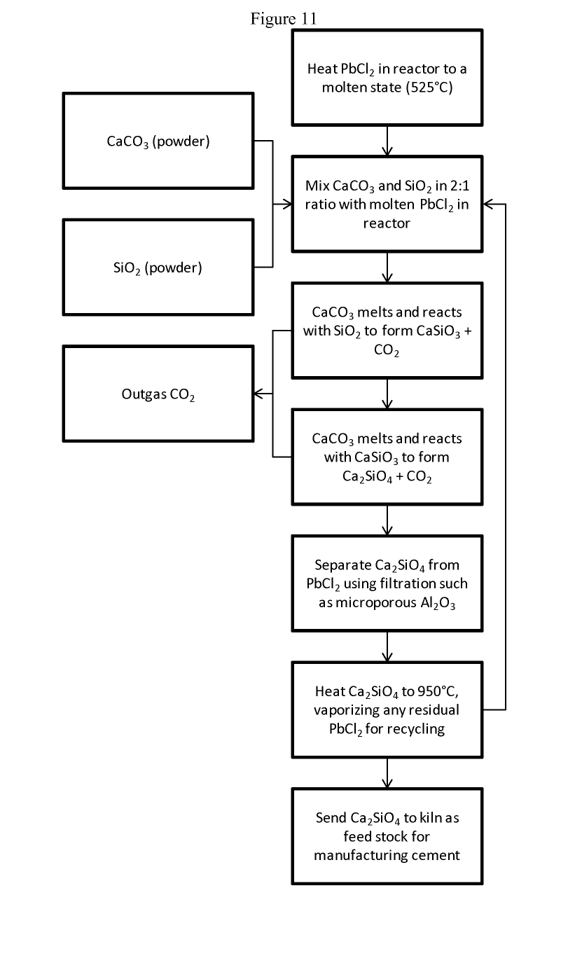

As with the embodiment of CaSiO₃ described above, the Ca₂SiO₄ produced using the methods disclosed herein are useful as feedstock for the production of Ca₃SiO₅ by combining it with lime in a tradition kiln. A simplified process diagram is presented in FIG. 10.

An example of the envisioned Reactor utilizing a salt melt of PbCl₂ to produce Ca₂SiO₄ cement precursors is as follows (FIG. 11):

1. A PbCl₂ salt bath is heated to melting in a container made of Al₂O₃ or possibly MgAl₂O₄. PbCl₂ melts by itself at 501° C., so there is no danger of solidification at approximately 525° C. The density of the salt bath is estimated at 4.92 g/cm³ with a viscosity of less than 4.0 centipose. Because of the moderate temperatures required, use of “waste heat”, typically exhaust from the kiln or precalciner, along with renewable or green heat sources is possible.

2. CaCO₃ and SiO₂ (most likely as limestone and silica) are mixed and heated to 525° C. in a 2:1 ratio.

3. The heated raw materials are introduced into the salt bath or mix with PbCl₂ as a sintering fluid, where the limestone becomes at least partially liquid and reacts with the silica to release CO₂ as gas to initially form CaSiO₃.

4. Additional limestone becomes at least partially liquid and reacts with CaSiO₃, releasing CO₂, to form Ca₂SiO₄.

5. Sodium and Potassium will become chloride salts, converting lead chloride into lead oxide. A small amount of lead oxide will not adversely impact the resulting cement, but impurity levels in the salt bath will require monitoring over time and can be countered by the addition of small amounts of calcium chloride, leading to the creation of calcium oxide and lead chloride.

6. Chloride and bromide impurities from the raw materials, possibly including coal ash, will remain in the salt bath as the temperature of the bath is high enough to cause them to melt but not so high as to result in vaporization.

7. Unlike CaCO₃, the mineral Ca₂SiO₄ does not melt in the salt bath and therefore will float to the surface (all have densities substantially lower than the salt bath).

8. Ca₂SiO₄ is primarily separated from the salt bath via a small pore size (typically less than 10 um), high porosity filter made of Al₂O₃ or MgAl₂O₄.

9. Molten salt sticking to the surface of the Ca₂SiO₄ is removed through the vaporization of any remaining PbCl₂ at 950° C., returning the salt to the salt bath.

10. Exhaust fumes can be further filtered through water containing trace amounts of Ca(OH)₂ or another appropriate salt that will interact with any remaining PbCl₂, resulting in the creation extremely insoluble and easily recoverable Pb(OH)₂. The water used to capture any residual lead is easily filtered using low-cost commercially available water filtration technology. Filtering of this sort should result in virtually 100% containment and recycling of lead containing compounds.

11. Ca₂SiO₄ is sent into the kiln to interact with CaO from the precalciner, forming clinker nodules of portland cement using traditional cement making methods.

Ca₂SiO₄ produced using the method disclosed herein can be used as feedstock for the production of alpha/beta-Ca₂SiO₄ and Ca₃SiO₅ in a traditional kiln, thereby significantly reducing the “thermal bottleneck”. As shown in Table 9 below, using a salt melt to produce Ca₂SiO₄ can shift the “thermal bottleneck” from 900° C. to approximately 500° C., resulting in a 28.6% reduction in energy consumption and 12.3% reduction in CO₂ emissions versus the traditional kiln with pre-calciner process (accounting for CO₂ from both calcination and burning coal).

TABLE 9
Simplified ideal heat balance using a salt melt to generate Ca₂SiO₄

| Position in | Temperature | | Heat required |
|---|---|---|---|
| kiln system | (° C.) | Process | (kJ/kg) clinker |
| Preheater | 25-500 | Heating feed from 25° C. to 500° C. | +736^{(a)} |
| | 100-500 | Dehydrate clay | +63 |
| Salt Melt | 500 | Creation of dicalcium silicate in melt | +776 |
| | | (2CaCO₃ (s) + SiO₂ (s) → Ca₂SiO₄ (s) + 2CO₂ (g)) | |
| Calciner | 500-900 | Heating feed from 500° C. to 900° C. | +573 |
| | 900 | Dissociation of calcite (CaCO₃ (s) → CaO (s) + CO₂ (g)) | +743 |
| | 900-500 | Captured heat of generated CO₂ cooling from 900° C. down to 500° C. | −97 |
| Rotary kiln | 900-1450 | Heating feed from 900° C. to 1450° C. | +591 |
| | 1450 | Formation of clinker phases | +48 |
| Clinker cooler | 1450-900 | Captured heat from cooling of clinker from 1450° C. down to 900° C. | −599 |
| | 900-500 | Captured heat from cooling of clinker from 900° C. down to 500° C. | −413 |
| | 500-25 | Captured heat from cooling of clinker from 500° C. down to 25° C. | −418^{(b)} |
| | 500-25 | Captured heat of generated CO₂ cooling from 500° C. down to 25° C. | −255^{(b)} |
| | | Net heat required | +1748 |
| | | Net heat required at or above “thermal bottleneck” (500° C.) | +1623 |
| | | Net heat value of coal required at 10% excess air | +2028 |
| | | Net heat value of coal required at 10% excess air accounting for | +2134^{(c)} |
| | | heat losses | |

^{(a)}Assumes dry limestone and clay as kiln feed.
^{(b)}It is not considered practical to recover heat from kiln exit gases below about 120° C. due to the problems engendered by the condensation of water.
^{(c)}Heat loss from all sources estimated as 20.0% of the difference between the heat content of air at 25° C. and the heat content at a given temperature.

Forming Ca₂SiO₄ prior to sending the reactants to the kiln thus enhances production capacity. As shown below in Table 10, approximately 20.9% of kiln time is consumed forming CaSiO₃ and Ca₂SiO₄ from CaO and SiO₂. Forming Ca₂SiO₄ prior to sending the reactants to the kiln reduces the required kiln time by 20.9%, raising kiln throughput by 26.4%.

TABLE 10
Thermodynamic equations for production of Ca₃SiO₅

| | | | Theoretical portion | |
|---|---|---|---|---|
| | | Gibbs Energy of | of kiln time for | Equation |
| Temperature | Reaction Equation | Formation | formation | Number |
| At 1450° C.: | CaO (l) + SiO₂ (s) → CaSiO₃ (s) | ΔG_{f} = −127.0 kJ/mol | 6.4% | (13) |
| | CaO (l) + CaSiO₃ (s) → Ca₂SiO₄ (s) | ΔG_{f} = −84.8 kJ/mol | 14.5% | (14) |
| | CaO (l) + Ca₂SiO₄ (s) → Ca₃SiO₅ (s) | ΔG_{f} = −36.3 kJ/mol | 79.1% | (15) |

(13-15) At 1450° C. the liquid-solid interactions between the reactants will proceed rapidly. Reaction speed is estimated to be proportional to 1/(ΔG_{f}²).

Insoluble Ca₂SiO₄ can be separated from LiCl—CaCl₂ via washing or filtering. Alternatively, a melt of PbCl₂ will have a higher density than the resulting solid Ca₂SiO₄, so the Ca₂SiO₄ will float to the surface of the melt where it can be removed by mechanical means. The Ca₂SiO₄ will be fairly pure as molten PbCl₂ exhibits a viscosity of less than 4.0 cP (centipoise), allowing the removal of most of the salt medium with the application of mild centrifugal forces. Further purification is possible through the vaporization and recycling of any remaining PbCl₂ just above 950° C.

A further examination of XRD (powder x-ray diffraction) data has led to the determination that several experiments to simulate the creation of Ca₃Si₂O₇ produced results which verify the processing methodology.

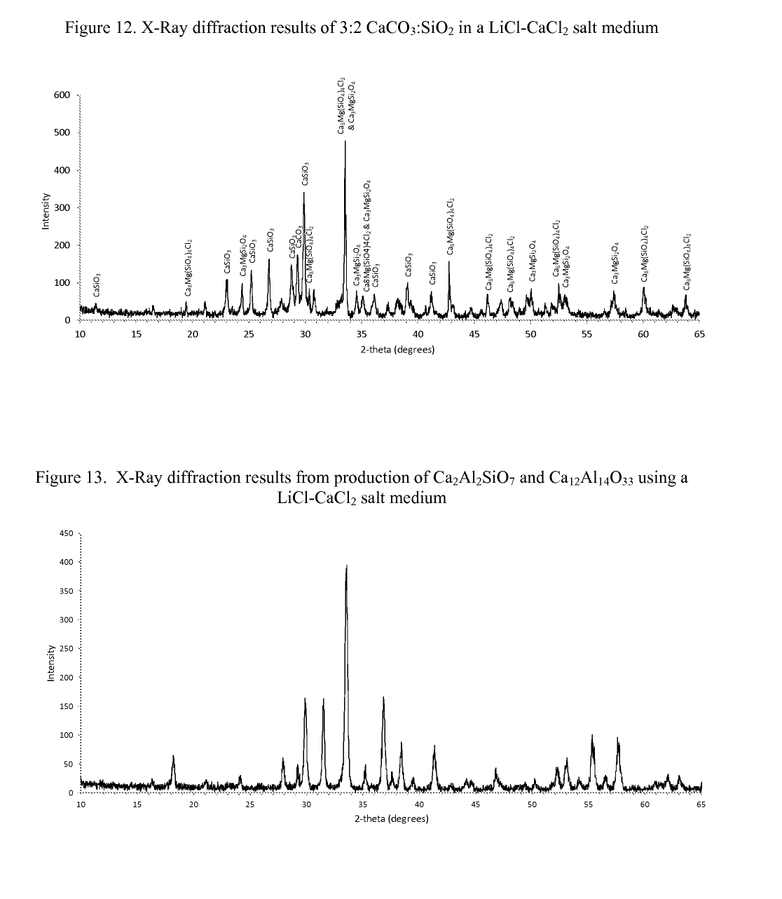

More specifically returning to FIG. 12, the heating of a 3:2 ratio of CaCO₃ and SiO₂ does not result in the production of 3:2 ratio calcium silicates such as Rankinite (Ca₃Si₂O₇), but instead produces a mixture of 1:1 and 2:1 calcium silicates and calcium silicate chlorides such as Rondorfite (Ca₈Mg(SiO₄)₄Cl₂). The phase diagram of CaO-SiO₂ is well established and the stability of Ca₃Si₂O₇ at all temperatures below a decomposition temperature of approximately 1350° C. is undisputed, yet Rankinite is not produced in a molten salt reactor. Thermodynamics indicate that the creation of Ca₃Si₂O₇ is favorable above 400° C. as a two-step process:

CaCO₃ (1)+SiO₂(s)->CaSiO₃(s)+CO₂(g) (16)

CaCO₃ (1)+2CaSiO₃(s)->Ca₃Si₂O7(s)+CO₂(g) (17)

However, as the reaction in equation 17 indicates, the reaction is dependent on the simultaneous interaction of one liquid (CaCO₃) and two solids (2×CaSiO₃)—an unlikely scenario even in a stirred vessel given the low mobility of solids. Thus, the creation of 1:1 and 2:1 calcium silicates is not unexpected. Furthermore, trace impurities such as MgO are frequently found in CaCO₃, so the appearance of alternative crystalline structures such as Monticellite (Ca₃MgSi₂O₄) is also to be expected. Finally, the appearance of Rondorfite (Ca₈Mg(SiO₄)₄Cl₂) demonstrates how important it is to select an appropriate salt medium as CaCl₂ has been shown to be useful in the creation of 1:1 calcium silicates but is clearly not appropriate for the creation of 2:1 calcium silicates due to the inevitable creation of calcium silicate chlorides.

The appearance of other less common mineral structures should be expected depending on the exact impurities found in the reactants and their abundance in the reactants. Regardless of the impurities found, the molar ratio of CaO:SiO₂ in compounds formed by CaO and SiO₂ is expected to generally remain in the range of 1:2 (e.g. CaSi₂O₅) to 3:1 (e.g. Ca₃SiO₅) when both CaO and SiO₂ are present and interact.

The appearance of other less common mineral structures should be expected depending on the exact impurities found in the reactants and their abundance in the reactants. Regardless of the impurities found, the molar ratio of CaO:Al₂O₃ in compounds formed by CaO and Al₂O₃ is expected to generally remain in the range of 1:2 (e.g. CaAl₄O₇) to 3:1 (e.g. Ca₃Al₂O₄) when both CaO and Al₂O₃ are present and interact.

Other less common mineral structures expected depending on the exact impurities found in the reactants and their abundance in the reactants. Regardless of the impurities found, the molar ratio of CaO:Al₂O₃ in compounds formed by CaO and Fe₂O₃ is expected to generally remain in the range of 1:2.5 (e.g. CaFe₅O₇) to 1:1 (e.g. CaFe₂O₄) when both CaO and Fe₂O₃ are present and interact.

Yet other less common mineral structures expected depending on the exact impurities found in the reactants and their abundance in the reactants. The molar ratio of SiO₂:Al₂O₃ in compounds formed by SiO₂ and Al₂O₃ is expected to generally remain in the range of 1:3 (e.g. SiO₂.3Al₂O₃) to 2:1 (e.g. 2SiO₂.Al₂O₃) when both SiO₂ and Al₂O₃ are present and interact.

B. Embodiments based on CaCO₃ and clay containing primarily SiO₂ and Al₂O₃

Embodiments of the invention based on CaCO₃ and clay containing primarily SiO₂ and Al₂O₃ can be divided into the same two major sub-categories as embodiments based on CaCO₃ and SiO₂, namely embodiments for the production of CaSiO₃ and Ca₂SiO₄. In both of these sub-categories, the difference between embodiments containing only SiO₂ and embodiments containing on SiO₂ plus Al₂O₃ is the potential creation of calcium aluminates and calcium aluminosilicates. The primary minerals of interest are CaAl₂O₄, CaAl₄O₇, Ca₁₂Al₁₄O₃₃, Ca₃Al₂O₆, CaAl₂SiO₆, Ca₂Al₂SiO₇, CaAl₂Si₂O₈, and Ca₃Si₃Al₂O₁₂ (“CA”,

“CA2”, “C12A7”, “C3A”, “CAS”, “C2AS”, “CA2S” and “C3AS3”, respectively in shorthand notation). As shown in Table 11, the production of the calcium aluminosilicates Ca₂SiAl₂O₇ and Ca₃Si₃Al₂O₁₂ and the calcium aluminate Ca₁₂Al₁₄O₃₃ are energetically favorable in the presence calcium carbonate at 500° C. While these calcium aluminosilicates and calcium aluminates slightly alter the stoichiometry of the reactions previously discussed, they all interact in the presence of additional lime to move the reaction towards the production of Ca₃SiO₅ and Ca₃Al₂O₆, two of the end products in Portland cement, and thus their impact on the overall process and energy balance is beneficial.

TABLE 11
Thermodynamic equations involving Aluminates and Aluminosilicates

| | | Enthalpy of | Gibbs Energy | |
|---|---|---|---|---|
| | | Formation | of Formation | Equation |
| Temperature | Reaction Equation | (ΔH_{f)} | (ΔG_{f)} | Number |
| At 500° C.: | Al₂Si₂O₇(2H₂O) → Al₂Si₂O₇ + 2H₂O(g) | +291.5 kJ/mol | +53.0 kJ/mol | (18) |
| | CaCO₃ (l) + Al₂O₃ (s) → CaAl₂O₄ (s) + CO₂ (g) | +145.9 kJ/mol | +19.4 kJ/mol | (19) |
| | CaCO₃ (l) + CaAl₄O₇ (s) → 2CaAl₂O₄ (s) + CO₂ (g) | +152.8 kJ/mol | +38.6 kJ/mol | (20) |
| | CaCO₃ (l) + CaAl₂O₄ (s) → Ca₂Al₂O₅ (s) + CO₂ (g) | +165.3 kJ/mol | +58.3 kJ/mol | (21) |
| | CaCO₃(l) + Al₂Si₂O₇(2H₂O) → CaAl₂Si₂O₈ + CO₂(g) + 2H₂O(g) | +193.0 kJ/mol | −165.3 kJ/mol | (22) |
| | CaCO₃(l) + CaAl₂Si₂O₈ → CaAl₂SiO₆ + CaSiO₃ + CO₂(g) | +95.5 kJ/mol | −10.9 kJ/mol | (23) |
| | CaAl₂SiO₆ + 2CaSiO₃ → Ca₃Al₂Si₃O₁₂ | −84.2 kJ/mol | −30.4 kJ/mol | (24) |
| | CaCO₃(l) + CaAl₂SiO₆ → Ca₂Al₂SiO₇ + CO₂(g) | +98.3 kJ/mol | −26.9 kJ/mol | (25) |
| | 5CaAl₂O₄ (s) → Ca₃Al₂O₆ (s) + 2CaAl₄O₇ (s) | +26.1 kJ/mol | −0.1 kJ/mol | (26) |
| | 17CaAl₂O₄ (s) → Ca₁₂Al₁₄O₃₃ (s) + 5CaAl₄O₇ (s) | +66.9/mol | −46.3 kJ/mol | (27) |
| | Ca₂SiO₄ (s) + Al₂O₃ (s) → Ca₂SiAl₂O₇ (s) | +0.5 kJ/mol | −18.7 kJ/mol | (28) |
| | 3CaSiO₃ (s) + Al₂O₃ (s) → Ca₃Si₃Al₂O₁₂ (s) | −67.3 kJ/mol | −21.7 kJ/mol | (29) |

(18-21) ΔG_{f} shows that none of the equations are favorable at 500° C.
(22-27) ΔG_{f} shows that the formation decarbonation of CaCO3 is favorable in the presence of aluminosilicates and that the creation of C7A12 and CAS2 are favored versus other aluminosilicates and aluminates.
(28-29) ΔG_{f} shows that calcium aluminosilicates are favored over free alumina at 500° C.

1) Embodiment to produce CaSiO₃, calcium aluminates and calcium aluminosilicates

An embodiment to produce CaSiO₃, calcium aluminates and calcium aluminosilicates, specifically Ca₂SiAl₂O₇, Ca₃Al₂Si₃O₁₂ and Ca₁₂Al₁₄O₃₃, utilizes a molten salt medium to support a direct interaction between molten CaCO₃ and clay such as Kaolinite (Al₂Si₂O₅(OH)₄) in accordance primarily with equations (3-5) and (22-24). Two examples of salt mediums for this embodiment are LiCl—CaCl₂ and PbCl₂. In the case of any reaction medium, properly proportioned amounts of CaCO₃ become molten in the salt medium. The reactions, which are favorable even below the eutectic temperature of the salt medium, proceed rapidly with a molten reactant as demonstrated by the pure substance calculations presented in Tables 5 and 11. X-ray diffraction results from experiments using a LiCl—CaCl₂ salt medium are presented in FIG. 13 and show the formation of Ca₂Al₂SiO₇, Ca₃Al₂Si₃O₁₂ and Ca₁₂Al₁₄O₃₃.

CaSiO₃, Ca₂Al₂SiO₇, Ca₃Al₂Si₃O₁₂, Ca₁₂Al₁₄O₃₃ and other calcium silicates and calcium aluminosilicates produced using the method disclosed herein can be used as feedstock for the production of Ca₂SiO₄, Ca₃SiO₅ and Ca₃Al₂O₆ in a traditional kiln, thereby reducing the “thermal bottleneck”. As shown in Table 12 below, using a salt melt to produce CaSiO₃, Ca₂Al₂SiO₇, Ca₃Al₂Si₃O₁₂ and Ca₁₂Al₁₄O₃₃ reduces the size of the “thermal bottleneck” at 900° C., resulting in a 22.9% reduction in energy consumption and 9.9% reduction in CO₂ emissions versus the traditional kiln with precalciner process (accounting for CO₂ from both calcination and burning coal).

TABLE 12
Simplified ideal heat balance to generate CaSiO₃ and Ca₂Al₂SiO₇

| Position in | Temperature | | Heat required |
|---|---|---|---|
| kiln system | (° C.) | Process | (kJ/kg) clinker |
| Preheater | 25-625 | Heating feed from 25° C. to 625° C. | +960^{(a)} |
| | 100-625 | Dehydrate clay | +63 |
| Salt Melt | 625 | Creation of calcium silicates and aluminosilicates in melt | +409 |
| | | CaCO₃ (l) + Al₂Si₂O₇(2H₂O) → CaAl₂Si₂O₈ + CO₂(g) + 2H₂O(g) | |
| | | CaCO₃ (l) + CaAl₂Si₂O₈ → CaSiO₃ (s) + CaAl₂SiO₇ + CO₂ (g) | |
| Calciner | 625-900 | Heating feed from 625° C. to 900° C. | +420 |
| | 900 | Dissociation of remaining calcite (CaCO₃ (s) → CaO (s) + CO₂ (g)) | +1248 |
| | 900-625 | Captured heat of generated CO₂ cooling from 900° C. down to 625° C. | −114 |
| Rotary kiln | 900-1450 | Heating feed from 900° C. to 1450° C. | +598 |
| | 1450 | Formation of clinker phases | −49 |
| Clinker | 1450-900 | Captured heat from cooling of clinker from 1450° C. down to 900° C. | −599 |
| cooler | 900-625 | Captured heat from cooling of clinker from 900° C. down to 625° C. | −292 |
| | 625-25 | Captured heat from cooling of clinker from 625° C. down to 25° C. | −428^{(b)} |
| | 625-25 | Captured heat of generated CO₂ cooling from 625° C. down to 25° C. | −333^{(b)} |
| | | Net heat required | +1883 |
| | | Net heat required at or above “thermal bottleneck” (900° C.) | +1198 |
| | | Net heat value of coal required at 10% excess air | +2012 |
| | | Net heat value of coal required at 10% excess air accounting for heat | +2304^{(c)} |
| | | losses | |

^{(a)}Assumes dry limestone and clay as kiln feed.
^{(b)}It is not considered practical to recover heat from kiln exit gases below about 120° C. due to the problems engendered by the condensation of water.
^{(c)}Heat loss from all sources estimated as 20.0% of the difference between the heat content of air at 25° C. and the heat content at a given temperature.

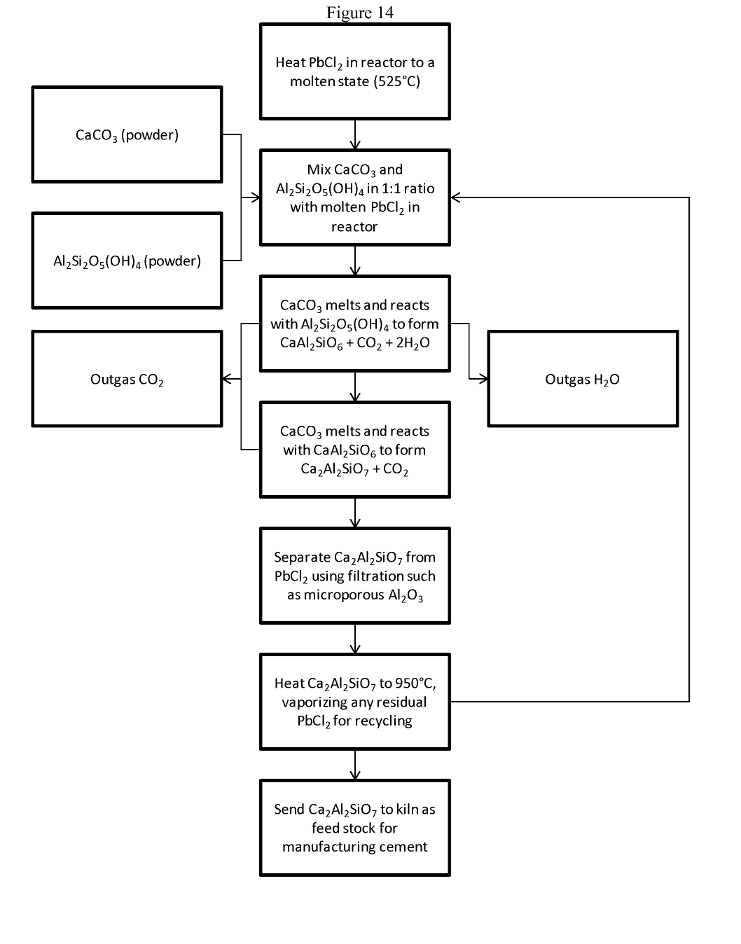

An example of the envisioned Reactor utilizing a salt melt of PbCl₂ to produce monocalcium silicate and calcium aluminosilicate cement precursors is as follows (FIG. 14):

1. A PbCl₂ salt bath is heated to melting in a container made of Al₂O₃ or possibly MgAl₂O₄. PbCl₂ melts by itself at 501° C., so there is no danger of solidification at approximately 525° C. The density of the salt bath is estimated at 4.92 g/cm³ with a viscosity of less than 4.0 centipose. Because of the moderate temperatures required, use of “waste heat”, typically exhaust from the kiln or precalciner, along with renewable or green heat sources is possible.

2. CaCO₃ and Al₂Si₂O₅(OH)₄ (most likely as limestone and koalinite or a related clay) are mixed and heated to 525° C. in an approximately 3:1 ratio .

3. The heated raw materials are introduced into the salt bath or mix with PbCl₂ as a sintering fluid, where the limestone becomes at least partially liquid and reacts with the kaolinite to release CO₂ and possibly H₂O as gases to form CaSiO₃, Ca₂SiAl₂O₇, Ca₃Si₂Al₂O₁₀ and Ca₃Al₂(SiO₄)₃. Ca₂SiO₄, along with other minerals, may also be formed depending on the ratio of the raw materials placed into the salt bath.

4. Sodium and Potassium will become chloride salts, converting lead chloride into lead oxide. A small amount of lead oxide will not adversely impact the resulting cement, but impurity levels in the salt bath will require monitoring over time and can be countered by the addition of small amounts of calcium chloride, leading to the creation of calcium oxide and lead chloride.

5. Chloride and bromide impurities from the raw materials, possibly including coal ash, will remain in the salt bath as the temperature of the bath is high enough to cause them to melt but not so high as to result in vaporization.

6. Unlike CaCO₃, CaSiO₃, Ca₂SiAl₂O₆, Ca₃Si₂Al2O₈, Ca₃Al₂(SiO₄)₃, Ca₂SiO₄ and other related minerals do not melt in the salt bath and therefore will float to the surface (all have densities substantially lower than the salt bath).

7. CaSiO₃, Ca₂SiAl₂O₆, Ca₃Si₂Al2O₈, Ca₃Al₂(SiO₄)₃, Ca₂SiO₄ and other related minerals are primarily separated from the salt bath via a small pore size (typically less than 10 um), high porosity filter made of Al₂O₃ or MgAl₂O₄.

8. Molten salt sticking to the surface of the CaSiO₃, Ca₂SiAl₂O₆, Ca₃Si₂Al2O₈, Ca₃Al₂(SiO₄)₃, Ca₂SiO₄ and other related minerals is removed through the vaporization of any remaining PbCl₂ at 950° C., returning the salt to the salt bath.

9. Exhaust fumes can be further filtered through water containing trace amounts of Ca(OH)₂ or another appropriate salt that will interact with any remaining PbCl₂, resulting in the creation extremely insoluble and easily recoverable Pb(OH)₂. The water used to capture any residual lead is easily filtered using low-cost commercially available water filtration technology. Filtering of this sort should result in virtually 100% containment and recycling of lead containing compounds.

10. CaSiO₃, Ca₂SiAl₂O₆, Ca₃Si₂Al2O₈, Ca₃Al₂(SiO₄)₃, Ca₂SiO₄ and other related minerals are sent into the kiln to interact with CaO from the precalciner, forming clinker nodules of portland cement using traditional cement making methods.

A similar implementation is contemplated for production of alumino-silicate cements, calcium sulfo-aluminate cements, calcium sulfate cements and fly ash substitute (should the demand for fly ash exceed availability).

CaSiO₃, Ca₂SiAl₂O₆, Ca₃Si₂Al2O₈, Ca₃Al₂(SiO₄)₃, Ca₂SiO₄ and other related minerals produced using the method disclosed herein can be used as feedstock for the production of alpha/beta-Ca₂SiO₄, Ca₃SiO₅ and Ca₃Al₂O₆ in a traditional kiln, thereby significantly reducing the “thermal bottleneck”.

2) Embodiment to produce Ca₂SiO₄, calcium aluminates and calcium aluminosilicates

An embodiment to produce Ca₂SiO₄, calcium aluminates and calcium aluminosilicates, utilizes a molten salt medium to support a direct interaction between molten CaCO₃ and clay such as Kaolinite (Al₂Si₂O₅(OH)₄) in accordance primarily with equations (11-12) and (22-24). Two examples of salt mediums for this embodiment are CuCl and PbCl₂. In the case of any reaction medium, properly proportioned amounts of CaCO₃ become molten in the salt medium. The reactions, which are favorable even below the eutectic temperature of the salt medium, proceed rapidly with a molten reactant as demonstrated by the pure substance calculations presented in Tables 8 and 11.

CaSiO₃, Ca₂Al₂SiO₇, Ca₁₂Al₁₄O₃₃ and other calcium silicates and calcium aluminosilicates produced using the method disclosed herein can be used as feedstock for the production of Ca₂SiO₄, Ca₃SiO₅ and C₃Al₂O₆ in a traditional kiln, thereby reducing the “thermal bottleneck”. As shown in Table 12 below, if a salt melt is used at 500° C. to produce Ca₂SiO₄, Ca₂Al₂SiO₇ and Ca₁₂Al₁₄O₃₃, the size of the “thermal bottleneck” at 900° C. can be reduced, resulting in a 29.3% reduction in energy consumption and 12.5% reduction in CO₂ emissions versus the traditional kiln with precalciner process (accounting for CO₂ from both calcination and burning coal).

TABLE 12
Simplified ideal heat balance to generate Ca₂SiO₄ and Ca₂Al₂SiO₇

| | | | Heat required |
|---|---|---|---|
| Position in | Temperature | | (kJ/kg) |
| kiln system | (° C.) | Process | clinker |
| Preheater | 25-500 | Heating feed from 25° C. to 500° C. | +736^{(a)} |
| | 100-500 | Dehydrate clay | +63 |
| Salt Melt | 500 | Creation of calcium silicates and aluminosilicates in melt | +481 |
| | | CaCO₃ (l) + Al₂Si₂O₇(2H₂O) → CaAl₂Si₂O₈ + CO₂(g) + 2H₂O(g) | |
| | | CaCO₃ (l) + CaAl₂Si₂O₈ → CaSiO₃ (s) + CaAl₂SiO₇ + CO₂ (g) | |
| Calciner | 500-900 | Heating feed from 500° C. to 900° C. | +592 |
| | 900 | Dissociation of remaining calcite (CaCO₃ (s) → CaO (s) + CO₂ (g)) | +1157 |
| | 900-500 | Captured heat of generated CO₂ cooling from 900° C. down to 500° C. | −151 |
| Rotary kiln | 900-1450 | Heating feed from 900° C. to 1450° C. | +581 |
| | 1450 | Formation of clinker phases | −40 |
| Clinker | 1450-900 | Captured heat from cooling of clinker from 1450° C. down to 900° C. | −599 |
| cooler | 900-500 | Captured heat from cooling of clinker from 900° C. down to 500° C. | −414 |
| | 500-25 | Captured heat from cooling of clinker from 500° C. down to 25° C. | −418^{(b)} |
| | 500-25 | Captured heat of generated CO₂ cooling from 500° C. down to 25° C. | −256^{(b)} |
| | | Net heat required | +1732 |
| | | Net heat required at or above “thermal bottleneck” (900° C.) | +1099 |
| | | Net heat value of coal required at 10% excess air | +2009 |
| | | Net heat value of coal required at 10% excess air accounting for heat losses | +2114^{(c)} |

^{(a)}Assumes dry limestone and clay as kiln feed.
^{(b)}It is not considered practical to recover heat from kiln exit gases below about 120° C. due to the problems engendered by the condensation of water.
^{(c)}Heat loss from all sources estimated as 20.0% of the difference between the heat content of air at 25° C. and the heat content at a given temperature.

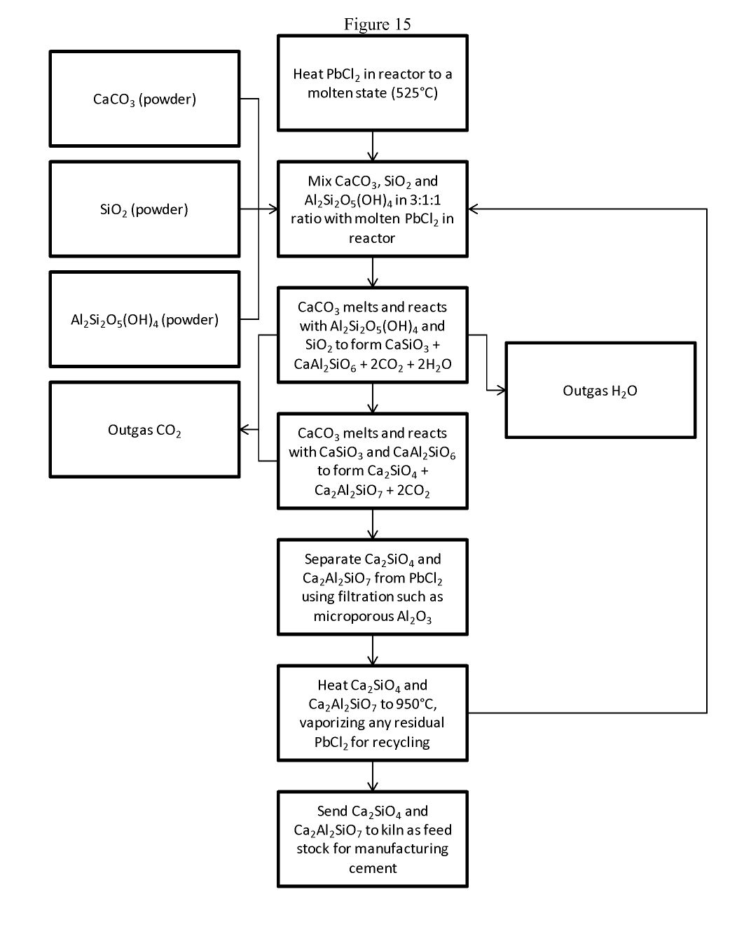

An example of the envisioned Reactor utilizing a salt melt of PbCl₂ to produce calcium silicate and calcium aluminosilicate cement precursors is as follows (FIG. 15):

1. A PbCl₂ salt bath is heated to melting in a container made of Al₂O₃ or possibly MgAl₂O₄. PbCl₂ melts by itself at 501° C., so there is no danger of solidification at approximately 525° C. The density of the salt bath is estimated at 4.92 g/cm³ with a viscosity of less than 4.0 centipose. Because of the moderate temperatures required, use of “waste heat”, typically exhaust from the kiln or precalciner, along with renewable or green heat sources is possible.

2. CaCO₃, SiO₂ and Al₂O₃ (most likely as limestone and koalinite or a related clay) are mixed and heated to 525° C. in an approximately 3:1:1 ratio (2[SiO2]+[Al2O3]≧[CaCO₃]>[SiO2]+[Al2O3]).

3. The heated raw materials are introduced into the salt bath or mix with PbCl₂ as a sintering fluid, where the limestone becomes at least partially liquid and reacts with the kaolinite and silica to release CO₂ and possibly H₂O as gases to form CaSiO₃, Ca₂SiAl₂O₆, Ca₃Si₂Al₂O₈, Ca₃Al₂(SiO₄)₃, Ca₂SiO₄, along with other minerals.

4. Sodium and Potassium will become chloride salts, converting lead chloride into lead oxide. A small amount of lead oxide will not adversely impact the resulting cement, but impurity levels in the salt bath will require monitoring over time and can be countered by the addition of small amounts of calcium chloride, leading to the creation of calcium oxide and lead chloride.

5. Chloride and bromide impurities from the raw materials, possibly including coal ash, will remain in the salt bath as the temperature of the bath is high enough to cause them to melt but not so high as to result in vaporization.

6. Unlike CaCO₃, CaSiO₃, Ca₂SiAl₂O₆, Ca₃Si₂Al2O₈, Ca₃Al₂(SiO₄)₃, Ca₂SiO₄ and other related minerals do not melt in the salt bath and therefore will float to the surface (all have densities substantially lower than the salt bath).

7. CaSiO₃, Ca₂SiAl₂O₆, Ca₃Si₂Al2O₈, Ca₃Al₂(SiO₄)₃, Ca₂SiO₄ and other related minerals are primarily separated from the salt bath via a small pore size (typically less than 10 um), high porosity filter made of Al₂O₃ or MgAl₂O₄.

8. Molten salt sticking to the surface of the CaSiO₃, Ca₂SiAl₂O₆, Ca₃Si₂Al2O₈, Ca₃Al₂(SiO₄)₃, Ca₂SiO₄ and other related minerals is removed through the vaporization of any remaining PbCl₂ at 950° C., returning the salt to the salt bath.

9. Exhaust fumes can be further filtered through water containing trace amounts of Ca(OH)₂ or another appropriate salt that will interact with any remaining PbCl₂, resulting in the creation extremely insoluble and easily recoverable Pb(OH)₂. The water used to capture any residual lead is easily filtered using low-cost commercially available water filtration technology. Filtering of this sort should result in virtually 100% containment and recycling of lead containing compounds.

10. CaSiO₃, Ca₂SiAl₂O₆, Ca₃Si₂Al2O₈, Ca₃Al₂(SiO₄)₃, Ca₂SiO₄ and other related minerals are sent into the kiln to interact with CaO from the precalciner, forming clinker nodules of portland cement using traditional cement making methods.

A similar implementation is contemplated for production of alumino-silicate cements, calcium sulfo-aluminate cements, calcium sulfate cements and fly ash substitute (should the demand for fly ash exceed availability).

CaSiO₃, Ca₂SiAl₂O₆, Ca₃Si₂Al2O₈, Ca₃Al₂(SiO₄)₃, Ca₂SiO₄ and other related minerals produced using the method disclosed herein can be used as feedstock for the production of alpha/beta-Ca₂SiO₄, Ca₃SiO₅ and Ca₃Al₂O₆ in a traditional kiln, thereby significantly reducing the “thermal bottleneck”.

Several alternative implementations of the Reactor have been identified and evaluated using thermodynamic analysis. These implementations fall into two broad categories: stand-alone and integrated. Stand-alone systems are completely independent from the kiln as they do not share heat with the kiln or other equipment. Stand-alone designs result in much lower energy savings, but are simpler and less expensive to implement. Integrated systems offer substantially greater energy savings but require “waste heat” from the kiln to be routed to the Reactor in addition to the pre-heaters and pre-calciner. Thus, integrated systems have the disadvantage of greater complexity and implementation cost. Table 13 summarizes the energy savings for stand-alone and integrated versions of the Reactor along with the experimental verifications carried out to date for various calcium silicate intermediaries.

TABLE 13
Energy savings for various calcium silicates and verifications completed to date

| | | Increase in | Experimental verification completed | | |
|---|---|---|---|---|---|
| | Energy | Manufacturing | Thermodynamic | | X-ray |
| Reactor Type & Intermediate Product | Savings | Capacity | Calculations | Reaction loss of mass | Diffraction |
| Calcium metasilicate (CaSiO₃) (stand-alone) | 2.9% | 28.5% | Yes | Yes | Yes |
| Tricalcium disilicate (Ca₃Si₂O₇) (stand-alone) | 9.5% | 28.5% | Yes | Yes | No (1) |
| Calcium orthosilicate (Ca₂SiO₄) (stand-alone) | 15.4% | 28.5% | Yes | Yes | Partial (2) |
| Calcium metasilicate (CaSiO₃) (integrated) | 21.1% | 28.5% | Yes | Yes | Yes |
| Tricalcium disilicate (Ca₃Si₂O₇) (integrated) | 31.1% | 28.5% | Yes | Yes | No (1) |
| Calcium orthosilicate (Ca₂SiO₄) (integrated) | 28.6% | 28.5% | Yes | Yes | Partial (2) |

(1) X-ray diffraction indicates that 3:2 mixes of CaCO₃ and SiO₂ form an amalgam of CaSiO₃ and Ca₂SiO₄-like compounds rather than Ca₃Si₂O₇. These results were not unexpected as CaCO₃ has a high mobility in the reactor while CaSiO₃, Ca₂SiO₄ and Ca₃Si₂O₇ have very low mobilities.
(2) X-ray diffraction indicates that 2:1 mixes of CaCO₃ and SiO₂ produce Ca₂SiO₄-like compounds but experiments are ongoing to determine the impact of impurities and potential interactions with various reactor catalysts.

As indicated above, all versions of the Reactor have been verified using thermodynamic analysis as well as laboratory experiments measuring the change in mass due to the loss of CO₂. The calcium metasilicate versions, which are the most straightforward, have also been verified in the laboratory with X-ray diffraction for confirmation of the reaction products.

Following are further aspects and features of the invention directed to a vessel construction or reactor for manufacture of the cement precursors as described. Thus, referring to FIG. 10, the starting materials are mixed and placed into a reactor 100. As the material becomes liquid during the process, the grain size is likely larger than the material used as kiln feed (approximately 75 um), but small enough to dissolve in a very short time—likely 200 to 300 um or less. The siliceous material is not expected to become liquid during the process, so the expected grain size is the same as in a kiln.

Multiple methods of heating the Reactor 100 can be used. The traditional approach and the approach used to calculate energy savings in this disclosure is to use the exhaust heat from the kiln 120 in the form of hot gases. However, electric coil heat from a green energy source like solar could be used.

The viscosity of the melt should be low, but the reaction mixture may be substantially thicker depending on the reactant load. Also, if the reactor medium is being used as a sintering additive or a molten bath—a sintering additive may require a rotating kiln while a molten bath would likely benefit from a stirred vessel or a turbulent river/flow reactor design.

X-ray fluorescence is a likely monitoring technique though examination of the surface may not effectively describe the contents of the mixture. X-ray fluorescence post-separation, pre-kiln introduction for the product and post-separation, pre-recycling for the reactor medium may also facilitate monitoring of production.

Alumina and iron oxide are candidates that need to move forward to the kiln. Alkalis, halides, and alkaline earth elements, along with Pb and Hg and elements should be maintained in the reactor medium for separation. Most impurities can be removed with the reactor medium which requires purifying and rebalancing the reactor medium.

Heat from the reactor may be sent to generate electricity after making sure it is clean or used to drive off loose H₂O.

Ideally, the reactor medium should be very low viscosity but higher density than the product (typical viscosity appears to be less than 4 centipose), so gravity is the primary separator. Additional separation will depend on the reactor medium in use, but most candidates have low enough viscosities that centrifugal force should be productive and at least a few promising candidates have vaporization temperatures under 1000° C.-PbCl₂ and PbBr₂ being two prime examples. Thus, most reactor medium will be removed via gravity with the remainder being removed and recycled upon heating the feed before sending it to the kiln.

To avoid the build-up of fumes (H₂O or CO₂) low airflow will reduce heat loss, but some circulation is required. Comparison to airflow through a kiln should be favorable.

Filtering is required to control environmental hazards (NOₓ, SOₓ, Pb, Hg).

The process should allow a wider range of input materials, especially slags and fly ash. These could result in significant cost and energy savings, but impurity issues may be a concern.

Alternative sources of silica or a wider range or input materials, especially slags and fly ash should result in significant additional cost and energy savings.

Lining for the reactor may be the same materials used to lime kilns. Alumina has worked well for producing calcium metasilicate, calcium aluminate and calcium aluminosilicate and has shown no damage when attempting to produce calcium orthosilicate but the salts used in initial trials (LiCl and CaCl₂) failed to produce calcium orthosilicate that could be rinsed with H₂O and confirmed via x-ray diffraction, so it is unclear if alumina is suitable. Magnesium oxide may react with alumina and/or silica to product a protective coating or layer. Magnesium aluminate may also be highly effective.

Impurities that can damage the system may include Fluorine (F). Likewise, Mercury (Hg) is likely to vaporize, creating an environmental hazard. Large amounts of CaCl₂ or alkali halides could poison the reactor medium, raising the melting point and resulting in the creation of a solid mass.

The density of the reactor medium varies with temperature enough that cycling between liquid and solid phase may damage to the system. The likelihood of damage is expected to be minimal as long as the reactor medium is molten.

Additional grinding between the reactor 100 and the kiln 120 (FIG. 10) is not expected as experiments produced an extremely fine powder—no clumping or clinkering was observed.

Thermodynamic equations teach that Al₂O₃ does not react favorably with CaCO₃ at the temperatures contemplated for the reactor—it needs to reach at least 700° C. before decarbonation occurs. However, Al₂O₃ is likely to react with CaSiO₃ at temperatures as low as 400° C. so some side reactions are to be expected. These reactions should not harm product. The worst situation would be if the formation of calcium aluminosilicates resulted in an inability to decarbonate additional CaCO₃ in situations where the goal is to create Ca₃Si₂O₇ or Ca₂SiO₄, but analysis and experiments to date suggest this is unlikely.

Thermodynamic equations teach that Fe₂O₃ does not react favorable with CaCO₃ at the temperatures contemplated for the reactor 100—it needs to reach at least 800° C. before decarbonation occurs. However, Fe₂O₃ may react with CaSiO₃ at temperatures as low as 500° C. so some side reactions may appear. These reactions should not harm product as the Fe₂O₃ carries through to the kiln 120.

A melt design as opposed to a sintering design opens up possibilities for less pre-grinding and results in faster reaction rates. A melt design should also be easier to stir and is similar to the successful laboratory experiments. On the other hand, a sintering system requires less reaction medium and less energy to maintain the temperature of the reaction medium. However, a sintering system may require more mixing, such as with a mini kiln. Mini kilns are known but it may require significant electrical power to turn and may not be acceptable with regard to heat transfer requirements.

The embodiments described thus far have been presented as idealized, compositionally simplified cement precursor systems. Variations in reactant composition, changes in the ratio of the reactants and the presence of minor concentrations of impurities may lead to different or more complex chemical reactions. In general, however, the ratio of the oxides provided by the source materials to form cement precursors should fall within the ranges set forth in equations 30-33, below ([ ] indicates quantity in moles):

2:1≧[CaO]:([SiO₂]—[Al₂O₃]—[Fe₂O₃])?≧1:2 (30)

1:1≧[CaO]:([Al₂O₃]—[SiO₂]—[Fe₂O₃])≧1:2 (31)

1:1≧[CaO]:([Fe₂O₃]—[Al₂O₃]—[SiO₂])≧1:2 (32)

((2×[SiO₂])+[Al₂O₃]+[Fe₂O₃])≧[CaO]≧(([SiO₂]+[Al₂O₃])/2+[Fe₂O₃]) (33)

In summary, the general aspect of the invention is the use of one or more liquid (typically molten) organic and/or inorganic salts as a sintering agent or medium in which the melting point of calcium carbonate is lowered to a temperature below the decarbonation temperature of calcium carbonate, to form CaO thereby allowing liquid calcium carbonate to more rapidly interact with Al₂O₃, SiO₂, Fe₂O₃ and minerals combining Al₂O₃, SiO₂ and Fe₂O₃ in various combinations, including those containing with water and/or various impurities

While several alternative forms, aspects and embodiments of the invention are disclosed herein, significant variations may be made in the details of the molten salt medium and/or molten salt flux, reactants and reaction pathway without departing from the spirit and scope of the invention. The spirit and scope of the appended claims are intended to cover all such alternative designs and uses of the invention. By way of example, but not by limitation, claimed cement precursors include products subject to further heat processing as well as compounds capable of forming cements and compounds by appropriate mixing with additional constituents and combinations of such additional steps and mixed components or compounds.

What is claimed is:

1. A process for producing precursor cement compounds selected from the group consisting of calcium silicates, calcium aluminates, aluminosilicates, calcium aluminosilicates, calcium ferrites, calcium aluminoferrites and a combination of said cement precursor compounds comprising the steps of:
combining a calcium carbonate (CaCO₃) source material with an oxide source material selected from the group containing of one or more of SiO₂, Al₂O₃, Fe₂O₃ and combinations thereof in a molten salt catalyst melt, said salt catalyst selected from the group consisting of CaCl₂, CaBr₂, PbCl₂, PbBr₂, SrCl₂, SrBr₂, LiCl, LiBr, NaCl₂, NaBr, NaI, KCl, KBr, KI, BaCl₂, BaBr₂, CuCl, CuCl₂, CuBr, CuBr₂ CdCl₂, CdBr₂, MnCl₂, MnBr₂, ZnCl₂, ZnBr₂, FeCl₂ and combinations thereof at a temperature less than about 800° C. to form at least one of said cement precursor compounds in the form of a particulate separable from said salt melt; and separating said precursor cement compound from said salt melt.

2. The process of claim 1 wherein the molar ratio of the calcium carbonate to the SiO₂ source is maintained in the range of 1:2 to 2:1±15%.

3. The process according to claim 1 wherein said salt catalyst renders said calcium carbonate a substantially reactive material at a temperature below 800° C.

4. A process for manufacture of a cement precursor product selected from the group consisting of calcium silicates, calcium aluminates, calcium aluminum silicates, calcium ferrites, calcium aluminum ferrites, aluminum silicates, variations thereof and combinations thereof comprising the steps of:
mixing a combination of a calcium carbonate source and one or more of a SiO₂ source compound, an Al₂O₃ source compound, and a Fe₂O₃ source compound with one or more salts selected from the group consisting of CaCl₂, CaBr₂, PbCl₂, PbBr₂, SrCl₂, SrBr₂, LiCl, LiBr, NaCl₂, NaBr, NaI, KCl, KBr, KI, BaCl₂, BaBr₂, CuCl, CuCl₂, CuBr, CuBr₂ CdCl₂, CdBr₂, MnCl₂, MnBr₂, ZnCl₂, ZnBr₂, FeCl₂ and combinations of said salts characterized by the ability to depress the melting point of calcium carbonate, said salts being generally chemically non-reactive with the source compounds in a reactor maintaining said combination at a temperature not exceeding about 800° C. for a time sufficient to form cement precursor compounds from a reaction melt or sinter of said combination; and
extracting said precursor compounds from said melt or sinter.

5. The process of claim 4 wherein said cement precursor compound comprises a calcium silicate compound.

6. The process of claim 4 wherein the molar ratio of the CaCO₃ to SiO₂ source is maintained in the range 1:2 to 2:1±15%.

7. The process of claim 4 including the further step of combining the precursor compound with a primarily CaO compound in a kiln for a sufficient time and temperature to form a cement clinker phase product.

8. The process of claim 7 wherein the said CaO compound and calcium silicate compound are combined in said kiln is in the molar range of about 1:2 to 3:1.

9. The process of claim 7 is combined with the SiO₂ source compound to form a cement precursor compound selected from the group consisting of CaSiO₃, CaSiO₄, and combinations thereof.

10. The process of claim 4 wherein said salts are inorganic.

11. A method for the manufacture of cement precursors comprising the steps of:
combining one or more salt compounds, a calcium carbonate (CaCO₃) source compound and one or more reactive source compounds selected from the group consisting of compounds capable of providing a source oxide of one or more of Al₂O₃, SiO₂, Fe₂O₃ and chemically reactive variants thereof to form a mixture;
heating the mixture to a temperature less than the decarbonation temperature of said calcium carbonate to effect decarbonation conversion of said CaCO₃ by release of CO₂ and combination of resultant CaO with one or more said reactive source compounds to form one or more resultant compounds selected from the group consisting of calcium silicates, calcium aluminates, calcium ferrites, calcium aluminoferrites, calcium aluminosilicates, and variants thereof said resultant compounds capable of comprising precursors for production of hydraulic cement; and
separating said resultant compounds from said from the salt compounds.

12. The process of claim 11 wherein said salt is selected from the group comprising CaCl₂, CaBr₂, PbCl₂, PbBr₂, SrCl₂, SrBr₂, LiCl, LiBr, NaCl₂, NaBr, NaI, KCl, KBr, KI, BaCl₂, BaBr₂, CuCl, CuCl₂, CuBr, CuBr₂ CdCl₂, CdBr₂, MnCl₂, MnBr₂, ZnCl₂, ZnBr₂, FeCl₂ and combinations thereof.

13. A product by the process of claim 1, 4 or 11.

14. The method of claim 1, 4, or 11 wherein the constituents are provided in a mixture in selected from the group set forth in the following table:

[symbol]

15. The method of claim 1, 4 or 11 wherein the nominal molar quantity of combined or mixed reactive source materials is substantially in conformance with the following reactive equations:
2:1≧[CaO]:([SiO₂]—[Al₂O₃]—[Fe₂O₃])≧1:2 (30)
1:1≧[CaO]:([Al₂O₃]—[SiO₂]—[Fe₂O₃])≧1:2 (31)
1:1≧[CaO]:([Fe₂O₃]—[Al₂O₃]—[SiO₂])≧1:2 (32)
((2x[SiO₂])+[Al₂O₃]+[Fe₂O₃])≧[CaO]≧(([SiO₂]+[Al₂O₃])/2+[Fe₂O₃]) (33).
